(19) United States
(12) Patent Application Publication
(10) Pub. No.: US 2026/0370495 A1
(43) Pub. Date: Nov. 19, 2026

(54) SYSTEMS AND METHODS FOR PASSWORDLESS USER AUTHENTICATION

(71) Applicant: Wells Fargo Bank, N.A., San Francisco, CA (US)

(72) Inventors: Vivek Kalyanaraman, Bangalore (IN); Anindya Sil, Kolkata (IN); Mehuli Mukherjee, Bangalore (IN); Sourav Ghosh, Bangalore (IN); Gaurav Balyan, Bangalore (IN)

(21) Appl. No.: 18/614,246

(22) Filed: Mar. 22, 2024

(51) Int. Cl. H04L 9/32; G06F 21/62; G06V 10/74; G06V 10/764; G06V 10/776

(52) U.S. Cl. CPC H04L 9/3271; G06F 21/6245; G06V 10/761; G06V 10/764; G06V 10/776

(57) ABSTRACT

Systems, apparatuses, methods, and computer program products are disclosed for providing passwordless user authentication. An example method includes receiving a user authentication request and facilitating an audio-visual authentication session comprising at least receiving one or more of audio input data or image input data and determining whether one or more of the audio input data or the image input data are valid. The example method further includes facilitating a challenge authentication session comprising at least retrieving one or more challenge questions and receiving a first user response to at least a first challenge question of the one or more challenge questions, where the first challenge question is characterized by a first degree of difficulty. The example method further includes determining whether the first user response to the first challenge question is valid and granting or denying one or more access permissions to a client computing device associated with a user.

### BACKGROUND

User authentication is a necessary security precaution for protecting sensitive and/or private data and information. However, bad actors may, in some instances, be able to circumvent conventional user authentication systems and techniques. Furthermore, conventional user authentication systems and techniques exhibit numerous drawbacks, inefficiencies, and limitations.

### BRIEF SUMMARY

Nearly every enterprise (e.g., financial institution, business, corporation, and/or the like) maintains sensitive data (e.g., user account data, employee data, internal data, financial data, proprietary information, personally identifiable information (PII)) in data storage platforms that may be accessible over various communications networks. As such, various security precautions must be undertaken to ensure the safety and integrity of sensitive data. One of the primary means for ensuring the safety and integrity of data is to limit access to the data by enforcing various user identity authentication protocols configured to ensure that individuals are only able to access data that is relevant to them. Users associated with various enterprises are commonly given access to digital user profiles and/or user accounts that are accessible via web-based software platforms and enable the users to access (e.g., view, edit, manage) their personal data and/or enterprise data that is relevant to the users.

In order to protect users and their sensitive data, conventional user authentication protocols typically involve validating a combination of a user identifier (e.g., a username, account number, device identifier) and a security key (e.g., a password, passcode) associated with an individual user before allowing the user to access any sensitive data or information. However, security key authentication and other conventional user authentication mechanisms are subject to various pitfalls and drawbacks. Conventional user authentication systems have proven to be expensive to maintain (e.g., financially and computationally), easy to compromise by bad actors, inconvenient for users, and may only have temporary validity.

For example, user authentication systems that rely on biometric data of a user (e.g., fingerprint data, retina data) to authenticate the user are costly and complex to maintain. For instance, programming a biometric-based user authentication system is a difficult task, especially on an enterprise scale, and is cumbersome to maintain. As another example, user authentication systems that rely on physical security tokens such as key fobs or smart identification badges to authenticate users also present various pitfalls and inefficiencies. For instance, physical security tokens are always at risk of being lost, stolen, or damaged, and are oftentimes inconvenient to use. Furthermore, physical security tokens are associated with a large financial expense for enterprises with large workforces. As yet another example, digital certificates associated with a user device such as a mobile device or laptop computer may be revoked due to various IT problems or cyberattacks, may expire due to various software policies, and are not easily scalable for wider use in an evolving enterprise framework.

In this regard, conventional user authentication systems can lead to a loss of sensitive data, a loss of access to sensitive data, a loss of capital, as well as a loss of enterprise efficiency. Furthermore, managing conventional user authentication systems may lead to the overconsumption of resources such as technological resources (e.g., to operate secured servers, virtual private networks (VPNs)) and/or manpower resources (e.g., time spent managing the complexities and inefficiencies of certain authentication mechanisms) as well as financial resources (e.g., replacing lost or stolen security tokens, scaling outdated software).

In contrast to conventional techniques for authenticating user identities, example embodiments described herein comprise a user authentication management system configured to provide dynamic passwordless user authentication. In example embodiments, the user authentication management system may, at least in part, (i) facilitate an audio-visual authentication session to capture and authenticate audio input data and/or image input data that is representative of a user based on one or more artificial intelligence (AI) algorithms, (ii) facilitate a challenge authentication session to capture user responses to customized challenge questions generated by an AI-based user authentication model, (iii) determine whether the user responses match expected responses generated by the AI-based user authentication model, and (iv) upon determining the user has correctly answered the customized challenge questions, grant access permissions to a client computing device associated with the user that enable the user to access a software application framework associated with a particular enterprise.

Accordingly, the present disclosure sets forth systems, methods, and apparatuses that provide dynamic passwordless user authentication. There are many advantages of these, and other embodiments described herein. One advantage the user authentication management system provides, as described herein, is an improvement to the functioning of the computing infrastructure of an enterprise, such as by reducing the burden on computing resources. For instance, the user authentication management system described herein reduces the computational complexity of authenticating one or more users to access a respective software application framework by, among other things, automating processes such as authenticating a user based on audio input data and/or video input data (e.g., voice input data, facial feature input data), authenticating the user based on a series of challenge questions automatically generated by an AI-based user authentication model based on a user persona associated with the user, and alerting an enterprise regarding suspected fraudulent activity. By automating these processes, greater efficacy and efficiency is realized because users are no longer responsible for keeping track of fixed credentials (e.g., passwords, passcodes, physical security tokens), and enterprises are no longer responsible for mitigating the problems associated with the user’s fixed credentials (e.g., resetting passwords, replacing physical security tokens). Additionally, less memory allocation and processor usage are required to complete authentication because entering various user credentials to complete a user authentication process is no longer required.

Another advantage of the user authentication management system, as described herein, is an improvement to network security technologies and/or authentication technologies by providing an increased security for data and information related to users and/or enterprises by leveraging an AI-based user authentication model to generate customized challenge questions to be administered during a challenge authentication session of a user authentication process. The customized challenge questions may be generated based on individual user personas associated with respective users, where the user personas are generated based in part on data related to both the online and offline activity of the user. The customized challenge questions may be scaled by the AI-based user authentication model such that the challenge questions range in difficulty and/or specificity to better counteract suspected fraudulent activity (e.g., due to previous failed login attempts, long user response times). If a user successfully completes the audio-visual authentication operations associated with the audio-visual authentication session and successfully answers one or more challenge questions of a series of challenge questions associated with a challenge authentication session, then a client computing device associated with the user may be granted access permissions enabling the client computing device to access a software application framework (e.g., via a user account) associated with a respective enterprise.

Moreover, the example embodiments described herein further improve upon the security of conventional user authentication systems as the AI-based user authentication model described herein may be configured to employ synthetically generated data representative of a user to anticipate fraudulent authentication attempts associated with the user. Such synthetic data may be used to train the user authentication model to anticipate fraudulent audio input and/or image input scenarios (e.g., a bad actor in the background of a user’s image input) and/or counteract computer-generated threats (e.g., AI-generated images (a.k.a. deep fakes), audio impersonation software, forced authentication attacks, and/or the like).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a user authentication management system.

FIG. 2 illustrates a schematic block diagram of example circuitry embodying a system device that may perform various operations in accordance with some example embodiments described herein.

FIG. 3 illustrates a schematic block diagram of example circuitry embodying a client computing device that may perform various operations in accordance with some example embodiments described herein.

FIGS. 4A-4B illustrate an example dataflow diagram for dynamically authenticating a user, in accordance with some example embodiments described herein.

FIG. 5 illustrates an example flowchart diagram for facilitating an audio-visual authentication session, in accordance with some example embodiments described herein.

FIG. 6 illustrates an example flowchart for generating customized challenge questions for a user based on an AI-generated user persona, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

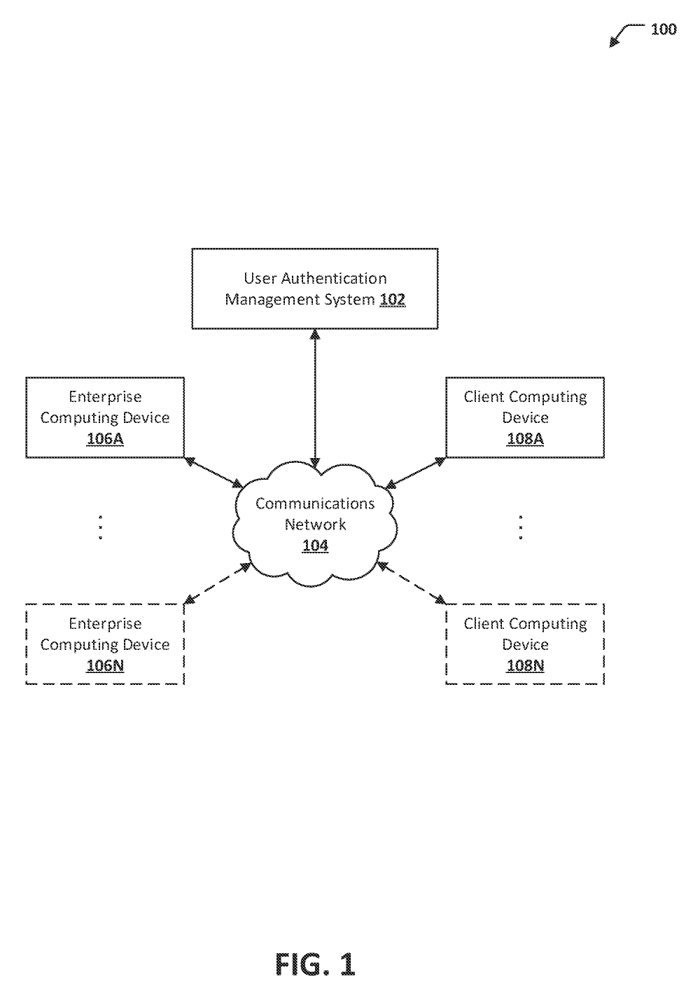

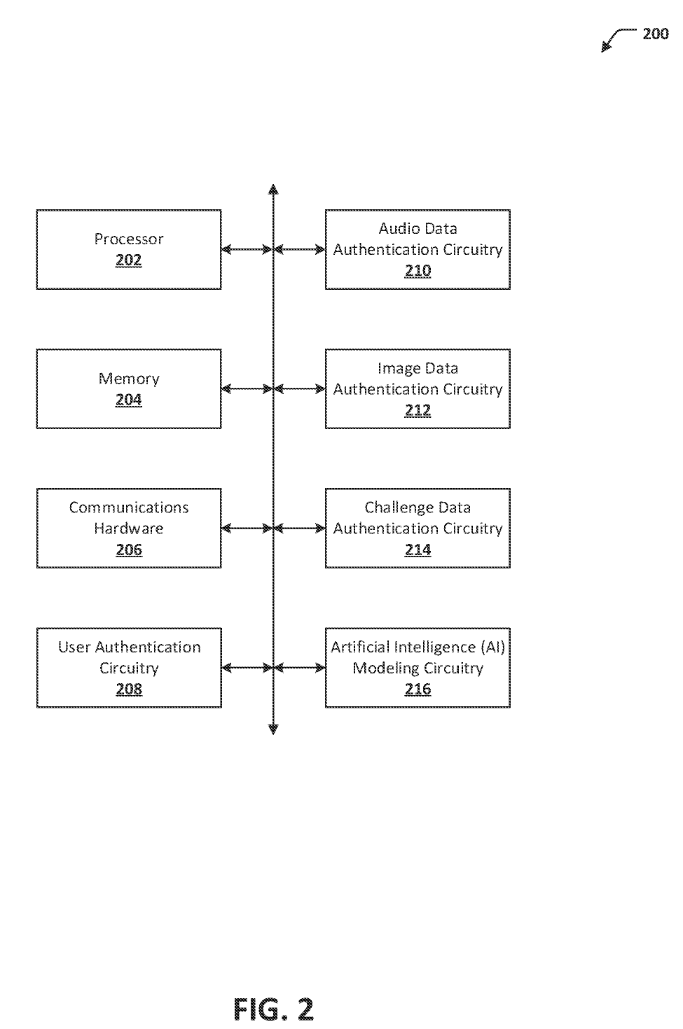

Example embodiments described herein may be implemented using any of a variety of computing devices or servers. To this end, FIG. 1 illustrates an example environment 100 within which various embodiments may operate. As illustrated, a user authentication management system 102 may receive and/ or transmit information via communications network 104 (e.g., the Internet) with any number of other devices, such as one or more of enterprise computing devices 106A-106N and/or client computing devices 108A-108N. The user authentication management system 102 may be implemented as one or more computing devices or servers, which may be composed of a series of components. Particular components of the user authentication management system 102 are described in greater detail below with reference to apparatus 200 in connection with FIG. 2.

In various embodiments, the user authentication management system 102 may be associated with an enterprise (e.g., a financial institution, bank, and/or the like) and may be configured to manage the various user authentication processes for said enterprise. For example, the user authentication management system 102 may be configured to manage, execute, initiate, and/or otherwise facilitate one or more user login processes, user credentialing processes, user identity verification processes, audio input data verification processes, image input data verification processes, computing device verification processes, user activity verification processes, user profile data verification processes, and/or the like for a plurality of users associated with a respective enterprise. In one or more embodiments, the user authentication management system 102 may be configured to authenticate one or more users and/or one or more user devices associated with the one or more users (e.g., enterprise computing devices 106A-106N, client computing devices 108A-108N, and/or the like) via the communications network 104.

In this regard, various users associated with an enterprise may interact with the user authentication management system 102 via a software application instance, where the software application instance may be configured to facilitate one or more of the various user authentication processes described herein. In various embodiments, the software application instance associated with the user authentication management system 102 may be installed and/or downloaded to a user device (e.g., a client computing device 108A configured as a mobile device, laptop, and/or the like) and may present one or more user interface configurations to a respective user.

As such, the software application instance associated with the user authentication management system 102 may be configured to guide a user through the various steps of a user authentication process. For example, the software application instance associated with the user authentication management system 102 may be configured to cause display of various interactive user interface elements to the user to facilitate the capture of various audio input data and/or image input data from the user, administer one or more customized challenge questions to the user, and/or enable the user to manage one or more portions of user data (e.g., user profile data, user persona data, and/or other user data). Additionally, in various embodiments, the software application instance associated with the user authentication management system 102 may be configured to enable a user to access a software application framework related to a respective enterprise by, for example, granting (e.g., transmitting, enabling, toggling, configuring) one or more access permissions for a user device (e.g., a client computing device 108A) associated with the user, where the one or more access permissions enable the user device to access the software application framework associated with the enterprise.

In various embodiments, the user authentication management system 102 may be configured to enable a respective user (e.g., a primary user) with various accessibility needs to allow a secondary user (e.g., a trusted user, caretaker) to complete one or more user authentication operations (in total, or in part) on behalf of the respective user. For example, a secondary user associated with the respective user may be authorized to provide, generate, and/or otherwise be associated with one or more portions of audio input data, image input data, and/or user response data to be utilized by the user authentication management system 102 to authenticate the respective user. Non-limiting examples of secondary users may include, but are not limited to, caretakers, personal healthcare aides, legal guardians, medical support personnel, legal custodians, and/or the like.

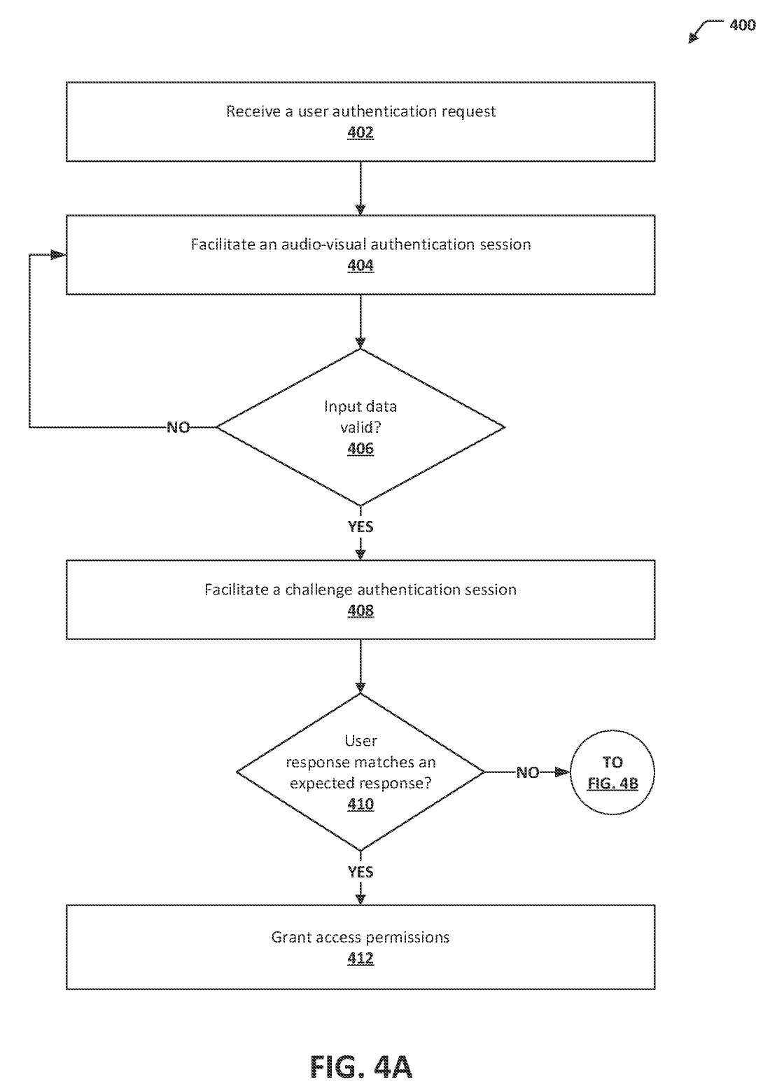

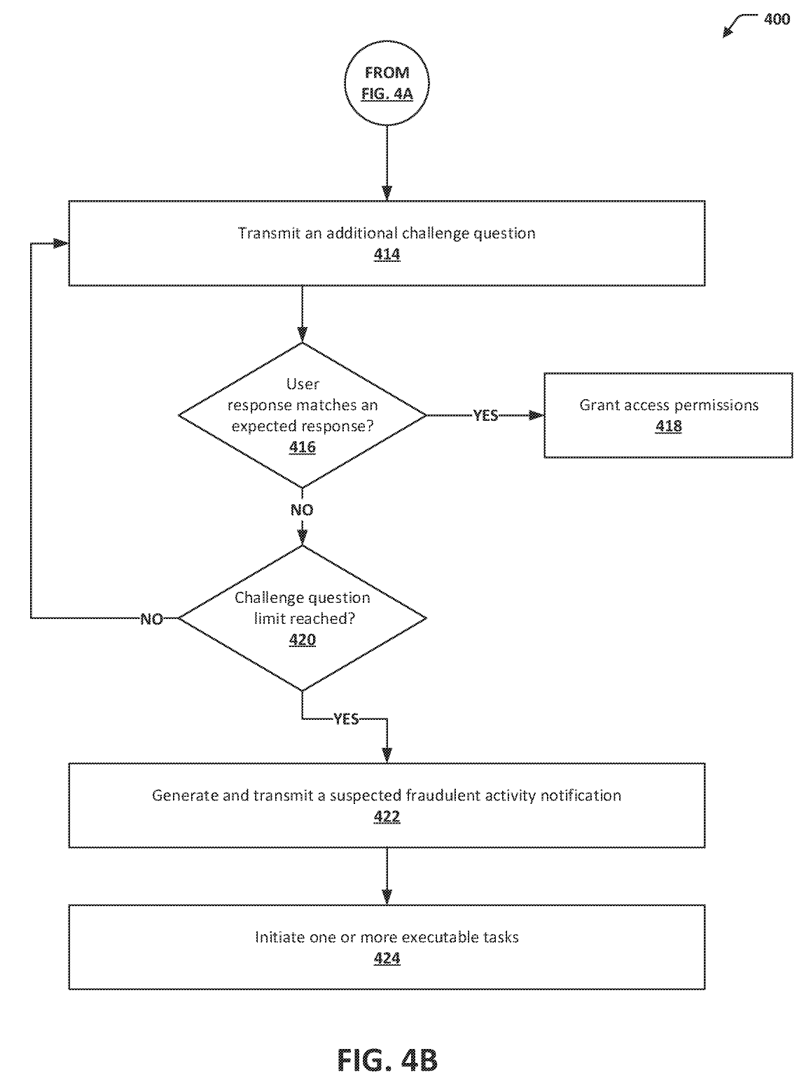

In some embodiments, the user authentication management system 102 includes, embodies, and/or otherwise integrates with a user authentication model configured to facilitate one or more of the various user authentication operations described herein. In various embodiments, the user authentication model may be configured to execute various machine learning (ML), machine vision (MV), artificial intelligence (AI), natural language processing (NLP), and/or generative AI techniques. For example, the user authentication model may be configured to process and/or extract features from one or more data sources (e.g., video data streams, audio data streams, text data streams, data stored in a storage device), either simultaneously or sequentially, to execute one or more facial recognition, body language recognition, and/or speech recognition techniques. In various embodiments, the user authentication model may be a supervised or unsupervised model and may be configured as an artificial neural network (ANN), recurrent neural network (RNN), convolutional neural network (CNN), or any other suitable deep learning model. In some embodiments, the user authentication management system 102 may train (e.g., initially, periodically, iteratively) a supervised user authentication model using supervised training techniques (e.g., using labeled training data, classification, regression) described herein to perform one or more operations described in further detail in connection with FIGS. 4A-4B and/or 5-6. In other embodiments, the user authentication management system 102 may train (e.g., initially, periodically, iteratively) an unsupervised user authentication model using unsupervised training techniques (e.g., using unlabeled training data, clustering, association) described herein to perform one or more operations described in further detail in connection with FIGS. 4A-4B and/or 5-6. Additionally or alternatively, the user authentication model may be configured to embody and/or integrate with one or more discrete AI models configured to perform a specific task associated with the methods described herein.

In some embodiments, the user authentication model may be configured as a generative AI model configured to automatically and dynamically facilitate the execution of one or more of the various techniques and/or methods described herein. For example, the user authentication model may be configured to generate a user persona for a respective user based on various types of data representative of the user stored in the storage device. In some embodiments, the data representative of the user utilized to generate a respective user persona may include, but is not limited to, biological data (e.g., age, height, weight, blood type, eye color), personal data (e.g., demographic data, residential address, work address, phone numbers, family members, contacts), online activity data (e.g., social media data, web browser history, search inquiry data), offline activity data (e.g., lifestyle data, hobby data, exercise habits, visited restaurants, eating patterns, visited locations, travel data), financial activity data (e.g., online banking history, mobile banking history, money withdrawals, money deposits, money transfers, credit card transactions, failed login attempts, purchases) accessibility data (e.g., personal health data, secondary user data (e.g., health aide profile data, caretaker profile data), communication needs, technological accessibility needs), challenge question response metrics (e.g., successful challenge question attempt data, unsuccessful challenge question attempt data, challenge question response time data), historical user authentication data, validated audio data (e.g., recorded and/or stored audio input data associated with successful user authentication attempts), validated image data (e.g., recorded and/or stored image input data associated with successful user authentication attempts), synthetic audio data (e.g., generated by the user authentication model), and/or synthetic image data (e.g., generated by the user authentication model) representative of the user.

Furthermore, the user authentication model may be configured to generate various synthetic data (e.g., synthetic audio data, synthetic image data, and/or the like) based on a user persona associated with a respective user. In various embodiments, the synthetic data may be employed to train and/or re-train the user authentication model to defend against various fraudulent user authentication attempts. For instance, the user authentication model may be configured to generate synthetic audio data and/or synthetic image data representative of the user based on their user persona in order to represent yet unknown scenarios that can be used to better authenticate future audio inputs and/or image inputs. In this manner, the user authentication model may better anticipate fraudulent audio input and/or image input scenarios and/or counteract computer-generated threats.

Additionally, the user authentication model may be configured to generate customized challenge questions to be administered to a respective user during a challenge authentication session of a user authentication process. The customized challenge questions may be generated based on the user persona associated with the respective user and may be scaled by the user authentication model such that the customized challenge questions range in difficulty, complexity, and/or specificity. For example, if a user fails to successfully answer a first challenge question associated with a first degree of difficulty (e.g., a low degree of difficulty), a second challenge question associated with a second degree of difficulty (e.g., a higher degree of difficulty) may be administered. In various example embodiments, the user authentication model may generate a series of customized challenge questions associated with an increasing degree of difficulty. In such embodiments, the user authentication management system 102 may administer increasingly difficult challenge questions to a respective user in response to detecting one or more of failed login attempts by the user, long user response times to previous challenge questions, and/or login attempts made on an unknown computing device.

In some embodiments, the user authentication management system 102 further includes a storage device that comprises a distinct component from other components of the user authentication management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the user authentication management system 102. Additionally or alternatively, the storage device may store information relied upon during operation of the user authentication management system 102, such as various user data (e.g., user persona data, user account data), AI model training data, AI model output data (e.g., synthetic image data, synthetic audio data, challenge question data), enterprise data (e.g., product and/or service data, distribution data, logistical data, legal data, software application framework data), and/or the like configured in various data formats to be utilized by the user authentication management system 102. In addition, the storage device may store control signals, device characteristics, and/or access credentials enabling interaction between the user authentication management system 102 and/or one or more of the enterprise computing devices 106A-106N or client computing devices 108A-108N.

In various embodiments, the one or more enterprise computing devices 106A-106N and/or the one or more client computing devices 108A-108N may be embodied by any computing devices known in the art. The one or more enterprise computing devices 106A-106N and/or the one or more client computing devices 108A-108N need not themselves be independent devices but may be peripheral devices communicatively coupled to other computing devices.

### Example Implementing Apparatuses

The user authentication management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 2-6. As illustrated in FIG. 2, the apparatus 200 may include processor 202, memory 204, communications hardware 206, user authentication circuitry 208, audio data authentication circuitry 210, image data authentication circuitry 212, challenge data authentication circuitry 214, and/or artificial intelligence (AI) modeling circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises user authentication circuitry 208. In some embodiments, the user authentication circuitry 208 may be configured to facilitate the execution of one or more user authentication processes for an enterprise associated with the user authentication management system 102. Additionally, the user authentication circuitry 208 may utilize processor 202, memory 204, or any other hardware component included in the apparatus 200 to perform these operations, as described in connection with FIGS. 4A-6 below. The user authentication circuitry 208 may further utilize the communications hardware 206 to gather data from, or transmit data to, a variety of sources (e.g., the enterprise computing devices 106A-106N, the client computing devices 108A-108N, and/or any storage devices associated with the user authentication management system 102), and/or exchange data with a user. In some embodiments, the user authentication circuitry 208 may work in conjunction with (e.g., may direct and/or otherwise manage) the audio data authentication circuitry 210, the image data authentication circuitry 212, the challenge data authentication circuitry 214, and/or the AI modeling circuitry 216 in order to execute one or more of the methods described herein. For example, in some embodiments, the user authentication circuitry 208 may integrate with and/or otherwise leverage the AI modeling circuitry 216 to employ a user authentication model to execute the various methods and operations described herein.

Furthermore, in various embodiments, the user authentication circuitry 208 may be configured to leverage the processor 202, the memory 204, and/or the communications hardware 206 to generate, cause transmission of, and/or cause display of a plurality of interactive user interface elements on a user interface associated with a software application instance associated with the user authentication management system 102 on a client computing device 108A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) designed to facilitate the capture of one or more portions of user input (e.g., audio input data, image input data, challenge question response data, text input data, and/or the like). Additionally, the plurality of interactive user interface elements may be configured to facilitate the display of data and/or information (e.g., challenge question data, user authentication attempt information, and/or user authentication status information). Additionally, in some embodiments, the user authentication circuitry 208 may utilize the processor 202, the memory 204, and/or the communications hardware 206 to facilitate one or more audio-visual authentication sessions and/or challenge authentication sessions for a user (e.g., via a software application instance associated with the user authentication management system 102) as the user attempts to log into a software application framework associated with a particular enterprise.

In addition, the apparatus 200 further comprises audio data authentication circuitry 210 that may be configured to facilitate the authentication of one or more portions of audio input data representative of a respective user. The audio data authentication circuitry 210 may utilize processor 202, memory 204, or any other hardware component included in the apparatus 200 (e.g., one or more microphones, such as a phone microphone, security camera microphone, automated teller machine (ATM) microphone, and/or the like) to perform these operations, as described in connection with FIGS. 4A-6 below. The audio data authentication circuitry 210 may further utilize communications hardware 206 to gather data from a variety of sources (e.g., enterprise computing devices 106A-106N, client computing devices 108A-108N, and/or any storage devices associated with the user authentication management system 102), and/or exchange data with a user, and in some embodiments may utilize processor 202 and/or memory 204 to generate an audio data similarity score based in part on executing an audio matching protocol. In some embodiments, the audio data authentication circuitry 210 may work in conjunction with the user authentication circuitry 208, the image data authentication circuitry 212, the challenge data authentication circuitry 214, and/or the AI modeling circuitry 216 in order to execute one or more of the methods described herein.

In various embodiments, the audio data authentication circuitry 210 may be configured to receive one or more portions of audio input data representative of a user. In some examples, the audio input data representative of the user may be captured by a client computing device (e.g., client computing device 108A) associated with the user during an audio-visual authentication session facilitated by the user authentication circuitry 208. In various examples, the audio input data representative of a user may include one or more portions of human speech generated by the user and/or one or more portions of audio data related to a background environment of the user.

In addition, the apparatus 200 further comprises image data authentication circuitry 212 that may be configured to facilitate the authentication of one or more portions of image input data representative of a respective user. The image data authentication circuitry 212 may utilize processor 202, memory 204, or any other hardware component included in the apparatus 200 (e.g., one or more cameras, such as phone cameras, thermal imaging cameras, security cameras, ATM cameras, and/or the like) to perform these operations, as described in connection with FIGS. 4A-6 below. The image data authentication circuitry 212 may further utilize communications hardware 206 to gather data from a variety of sources (e.g., enterprise computing devices 106A-106N, client computing devices 108A-108N, and/or any storage devices associated with the user authentication management system 102), and/or exchange data with a user, and in some embodiments may utilize processor 202 and/or memory 204 to generate an image data similarity score based in part on a comparison of image input data representative of a user to stored image data associated with the user. In some embodiments, the image data authentication circuitry 212 may work in conjunction with the user authentication circuitry 208, the audio data authentication circuitry 210, the challenge data authentication circuitry 214, and/or the AI modeling circuitry 216 in order to execute one or more of the methods described herein.

In various embodiments, the image data authentication circuitry 212 may be configured to receive one or more portions of image input data representative of a user. In some examples, the image input data representative of the user may be captured by a client computing device (e.g., client computing device 108A, web camera, smart phone, and/or other user devices) associated with the user during an audio-visual authentication session facilitated by the user authentication circuitry 208. In various examples, the image input data representative of a user may include one or more portions of still image data (e.g., pixels, contour lines, color gradients, contrast regions) and/or one or more portions of video data (e.g., video frames, pixels, contour lines, color gradients, contrast regions) captured with respect to the head, face, and/or body of the user. In some embodiments, the image input data may comprise one or more portions of still image data and/or one or more portions of video data (e.g., motion detection/recognition data) relating a user to a background environment. In some embodiments, the image input data may comprise one or more portions of still image data and/or one or more portions of video data (e.g., motion detection/recognition data) relating one or more first portions of a user’s body (e.g., face, ears, nose, mouth, hand) to one or more second portions of the user’s body (e.g., face, ears, nose, mouth, hand). For example, detecting motion of a user’s mouth or lips while speaking in a video without detecting motion of the user’s jaw line, throat, nose, or the like may be indicative of a high probability of falsified video data.

In addition, the apparatus 200 further comprises challenge data authentication circuitry 214 that may be configured to facilitate the authentication of a user based on one or more user responses to one or more customized challenge questions generated based on a user persona associated with the user. The challenge data authentication circuitry 214 may utilize processor 202, memory 204, or any other hardware component included in the apparatus 200 to perform these operations, as described in connection with FIGS. 4A-6 below. The image data authentication circuitry 212 may further utilize communications hardware 206 to gather data from a variety of sources (e.g., enterprise computing devices 106A-106N, client computing devices 108A-108N, social media networks, consumer banking servers, and/or any storage devices associated with the user authentication management system 102), and/or exchange data with a user, and in some embodiments may utilize processor 202 and/or memory 204 to generate, aggregate, compile, and/or otherwise process one or more challenge question response metrics associated with a respective user. In some embodiments, the challenge data authentication circuitry 214 may work in conjunction with the user authentication circuitry 208, the audio data authentication circuitry 210, the image data authentication circuitry 212, and/or the AI modeling circuitry 216 in order to execute one or more of the methods described herein.

In various embodiments, the challenge data authentication circuitry 214 may work in conjunction with the user authentication circuitry 208 to determine whether one or more user responses matches one or more respective expected responses to a plurality of challenge questions, where the one or more expected responses to the plurality of challenge questions are generated by the user authentication model based on a user persona associated with a respective user. For example, the challenge data authentication circuitry 214 may work in conjunction with the user authentication circuitry 208 to determine if one or more portions of user input data associated with a user response to a respective challenge question inputted via a user interface of a software application instance associated with the user authentication management system 102 matches an expected response (e.g., determined based on social media data, consumer banking spending data/patterns, and/or any other user persona data) to the respective challenge question.

In some embodiments, the challenge data authentication circuitry 214 may be configured to employ various challenge question answer-matching logic algorithms in order to determine whether a user response correctly matches an expected response. Additionally or alternatively, in various embodiments, the challenge data authentication circuitry 214 may employ various rules-based algorithms in order to determine whether a user response correctly matches an expected response. Additionally or alternatively, in various embodiments, the challenge data authentication circuitry 214 may employ fuzzy logic in order to determine whether a user response correctly matches an expected response. In this regard, the challenge data authentication circuitry 214 may be configured to determine whether two or more user responses may correctly match an expected response associated with a respective challenge question. Additionally or alternatively, the challenge data authentication circuitry 214 may be configured to determine that a respective challenge question may be associated with two or more expected responses.

In addition, the apparatus 200 further comprises AI modeling circuitry 216 that may be configured to integrate with, embody, direct, and/or otherwise manage a user authentication model associated with the user authentication management system 102. The AI modeling circuitry 216 may utilize processor 202, memory 204, or any other hardware component included in the apparatus 200 to perform these operations, as described in connection with FIGS. 4A-6 below. The AI modeling circuitry 216 may further utilize communications hardware 206 to gather data from a variety of sources (e.g., enterprise computing devices 106A-106N, client computing devices 108A-108N, and/or any storage devices associated with the user authentication management system 102), and/or exchange data with a user, and in some embodiments may utilize processor 202 and/or memory 204 to generate a user persona for a respective user, generate synthetic data representative of the user based in part on data associated with the respective user persona, and/or generate one or more customized challenge questions for the user based on the respective user persona. In some embodiments, the AI modeling circuitry 216 may work in conjunction with the user authentication circuitry 208, the audio data authentication circuitry 210, the image data authentication circuitry 212, and/or the challenge data authentication circuitry 214 in order to execute one or more of the methods described herein.

For example, in various embodiments, the AI modeling circuitry 216 may be configured to leverage a user authentication model to generate a user persona for a respective user based on various types of data representative of the user stored in a storage device associated with the user authentication management system 102. A user persona may be a digital representation of the respective user and may be associated with a user profile and/or user account managed by a particular enterprise employing the user authentication management system 102. Once a user persona is generated for a respective user, the various components of the apparatus 200 (e.g., the user authentication circuitry 208, challenge data authentication circuitry 214, AI modeling circuitry 216, and/or the like) may leverage the user persona (e.g., and/or data associated with the user persona) corresponding to the respective user to execute various user authentication processes for the respective user.

Furthermore, as described herein, the AI modeling circuitry 216 may leverage the user authentication model to generate customized challenge questions to be administered to a respective user during a challenge authentication session of a user authentication process. The customized challenge questions may be generated based on the user persona associated with the respective user and may be scaled (e.g., escalated and/or deescalated in difficulty) by the user authentication model such that the customized challenge questions range in difficulty, complexity, and/or specificity. For example, if a user fails to successfully answer a first challenge question associated with a first degree of difficulty (e.g., a low degree of difficulty), a second challenge question associated with a second degree of difficulty (e.g., a higher degree of difficulty) may be administered. In various example embodiments, the user authentication model may generate a series of customized challenge questions associated with an increasing degree of difficulty, complexity, and/or specificity. In such embodiments, the user authentication management system 102 (e.g., by way of the user authentication circuitry 208) may administer increasingly difficult challenge questions to a respective user in response to detecting one or more of failed login attempts by the user, long user response times to previous challenge questions, and/or login attempts made on an unknown computing device. Additionally, the AI modeling circuitry 216 may leverage the user authentication model to generate one or more expected responses to the series of customized challenge questions. In some examples, the AI modeling circuitry 216 may maintain the same and/or similar difficulty across (or between) various customized challenge questions. For example, three low degree of difficulty challenge questions may be administered. In another example, one low degree of difficulty challenge question may be administered then two higher degree of difficulty challenge questions may be administered. In some embodiments, a current login attempt may utilize the same, similar, and/or different (e.g., escalated and/or deescalated) degree of difficulty challenge question(s) from a previous login attempt (e.g., the last login attempt preceding the current login attempt).

Although components 202-216 are described in part using functional language, it will be understood that the particular implementations necessarily include the use of particular hardware. It should also be understood that certain of these components 202-216 may include similar or common hardware. For example, the user authentication circuitry 208, the audio data authentication circuitry 210, the image data authentication circuitry 212, the challenge data authentication circuitry 214, and/or the AI modeling circuitry 216 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the user authentication circuitry 208, the audio data authentication circuitry 210, the image data authentication circuitry 212, the challenge data authentication circuitry 214, and/or the AI modeling circuitry 216 may leverage processor 202, memory 204, and/or communications hardware 206 as described above, it will be understood that any of the user authentication circuitry 208, the audio data authentication circuitry 210, the image data authentication circuitry 212, the challenge data authentication circuitry 214, and/or the AI modeling circuitry 216 may include one or more dedicated processor, specially configured field programmable gate array (FPGA), or application specific interface circuit (ASIC) to perform its corresponding functions, and may accordingly leverage processor 202 executing software stored in memory (e.g., memory 204), or communications hardware 206 for enabling any functions not performed by special-purpose hardware. In all embodiments, however, it will be understood that the user authentication circuitry 208, the audio data authentication circuitry 210, the image data authentication circuitry 212, the challenge data authentication circuitry 214, and/or the AI modeling circuitry 216 comprise particular machinery (e.g., ATM, security cameras, and/or the like as described herein) designed for performing the functions described herein in connection with such elements of apparatus 200.

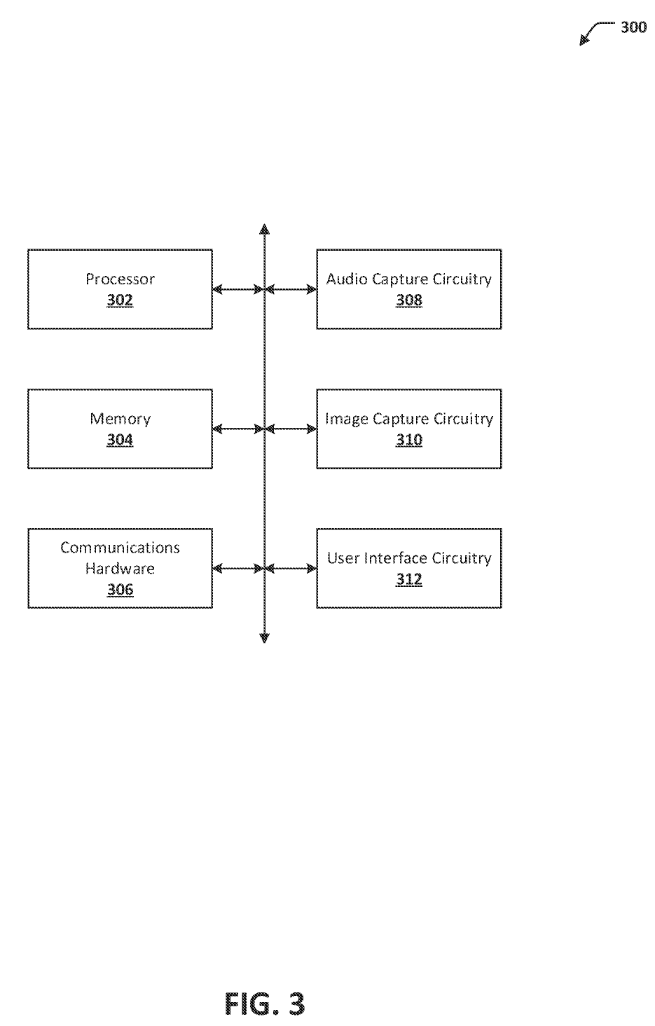

As illustrated in FIG. 3, an apparatus 300 is shown that represents an example enterprise computing device (e.g., any of enterprise computing devices 106A-106N) or an example user device (e.g., any of client computing devices 108A-108N). The apparatus 300 includes processor 302, memory 304, and communications hardware 306, each of which is configured to be similar to the similarly named components described above in connection with FIG. 2. Additionally, the apparatus 300 may also include audio capture circuitry 308, image capture circuitry 310, and/or user interface circuitry 312, each of which may be configured to facilitate the execution of the various methods described herein. For example, the audio capture circuitry 308, image capture circuitry 310, and/or the user interface circuitry 312 may be configured to generate, capture, aggregate, process, and/or otherwise manage one or more portions of audio input data, image input data, and/or user response data representative of a user and transmit the audio input data, image input data, and/or user response data to the user authentication management system 102 in order to facilitate the execution of one or more of the methods described herein.

The audio capture circuitry 308 includes hardware components designed for capturing one or more portions of audio input data representative of a respective user and/or causing transmission of the one or more portions of audio input data to the user authentication management system 102. In some embodiments, the audio capture circuitry 308 may utilize processor 302, memory 304, or any other hardware component included in the apparatus 300 (e.g., one or more microphones, such as a phone microphone, security camera microphone, ATM microphone, and/or the like) to perform the operations described in connection with FIGS. 4A-6 below. The audio capture circuitry 308 may comprise, embody, integrate with and/or otherwise control one or more audio capture devices associated with a client computing device (e.g., client computing device 108A) such as, for example, one or more microphones configured with any suitable polar pattern (e.g., a “pickup pattern,” a cardioid pattern, omnidirectional pattern, unidirectional pattern, bidirectional pattern, and/or the like) for capturing one or more audio signals generated by and/or associated with a respective user.

The audio capture circuitry 308 may be configured to capture audio input data representative of a user in real time or near-real time during an audio-visual authentication session being facilitated by the user authentication management system 102 (e.g., via a software application instance associated with the user authentication management system 102 being run on a client computing device (e.g., client computing device 108A) associated with the respective user). Additionally or alternatively, the audio capture circuitry 308 may be configured to capture audio input data representative of a user during a user authentication model training session (e.g., user-provided audio input data captured from the user while speaking for a predefined duration of time, reading from a script, and/or the like during a software application instance setup and/or configuration process). In various examples, the audio input data representative of a user may include one or more portions of human speech generated by the user and/or one or more portions of audio data related to a background environment of the user (e.g., crowd noise, street noise).

In addition, the apparatus 300 may also include the image capture circuitry 310. The image capture circuitry 310 includes hardware components designed for capturing one or more portions of image input data representative of a respective user and/or causing transmission of the one or more portions of image input data to the user authentication management system 102. In some embodiments, the image capture circuitry 310 may utilize processor 302, memory 304, or any other hardware component included in the apparatus 300 (e.g., one or more cameras, such as phone cameras, thermal imaging cameras, security cameras, ATM cameras, and/or the like) to perform the operations described in connection with FIGS. 4A-6 below. The image capture circuitry 310 may comprise, embody, integrate with and/or otherwise control one or more image capture devices associated with a client computing device (e.g., client computing device 108A) such as, for example, one or more cameras associated with one or more respective fields of view configured to capture image data and/or video data associated with a respective user.

The image capture circuitry 310 may be configured to capture image input data representative of a user in real time or near-real time during an audio-visual authentication session being facilitated by the user authentication management system 102 (e.g., via a software application instance associated with the user authentication management system 102 being run on a client computing device (e.g., client computing device 108A) associated with the respective user). Additionally or alternatively, the image capture circuitry 310 may be configured to capture image input data representative of a user during a user authentication model training session (e.g., user-provided image input data captured from the user during a software application instance setup and/or configuration process). In various examples, the image input data representative of a user may include one or more physical features associated with the respective user including, but not limited to, facial features (e.g., eyes, nose, mouth, ears, chin), eye features (e.g., shape, color, width), head features (e.g., size, shape), hair features (e.g., color, length), body composition features (e.g., body mass index, height, weight, demographic data, sex and/or gender data), mannerism features (e.g., facial expression features, body language features, body gesture features, ticks), sign language data, motion detection/recognition, and/or the like. Additionally, the image input data representative of a user may include one or more portions of image data related to a setting and/or background environment of the user. In some embodiments, the image input data representative of a user may include a relationship (e.g., relative detection/recognition, color contrast, shadowing) between two or more portions of image data (e.g., between two or more facial features, head features, body features, and/or a setting and/or background environment).

In addition, the apparatus 300 may also include the user interface circuitry 312, which includes hardware components designed for receiving user inputs and/or rendering virtual graphics outputs. The user interface circuitry 312 may utilize processor 302, memory 304, or any other hardware component included in, or integrated with, the apparatus 300 to perform these operations, as described in connection with FIGS. 4A-6 below. The user interface circuitry 312 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 312 may comprise one or more of a keyboard, pointing device, touchscreen, microphone with speech recognition interface, one or more cameras, and/or one or more other input devices capable of receiving various different user inputs. In addition, the user interface circuitry 312 may comprise a display device including one or more of a screen with graphical user interface (GUI), speaker, light emitting diode (LED), haptic technology device, and/or other output device capable of rendering information to a user. In this regard, the user interface circuitry 312 may be configured to facilitate the capture, generation, reception, transmission, and/or management of one or more portions of audio input data, image input data, user response data, and/or the like to be used for one or more user authentication operations executed by the user authentication management system 102.

Additionally, the user interface circuitry 312 may utilize processor 302, memory 304, or any other hardware component included in, or integrated with, the apparatus 300 to run, host, configure, and/or otherwise execute one or more operations, instructions, and/or commands related to a software application instance associated with the user authentication management system 102. For example, the user interface circuitry 312 may be configured allow a user to interact with the user authentication management system 102 via the software application instance in order to facilitate one or more user authentication operations (e.g., related to an audio-visual authentication session, a challenge authentication session, and/or any of the other methods described herein).

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4A-6, example flowcharts are illustrated that contain example operations implemented by example embodiments described herein. The operations illustrated in FIGS. 4A-6 may, for example, be performed by a system device (e.g., server) of the user authentication management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user authentication circuitry 208, audio data authentication circuitry 210, image data authentication circuitry 212, challenge data authentication circuitry 214, AI modeling circuitry 216, and/or any combination thereof. It will be understood that user interaction with the user authentication management system 102 may occur directly via communications hardware 206, or may instead be facilitated by a separate computing device (e.g., any of enterprise computing devices 106A-106N, and/or client computing devices 108A-108N shown in FIG. 1, which may in turn be embodied by an apparatus 300, which is shown and described in connection with FIG. 3), and which may have similar or equivalent physical componentry facilitating such user interaction.

Turning first to FIGS. 4A-4B, flowchart 400 illustrates example operations for dynamically authenticating a user.

As shown by operation 402, the apparatus 200 may include means, such as processor 202, memory 204, communications hardware 206 and/or the like, for receiving a user authentication request. For example, the communications hardware 206 may be configured to receive the user authentication request from a client computing device 108A associated with a respective user. In various embodiments, the user authentication request may be generated in response to one or more interactions with a user interface associated with a software application instance running on the client computing device 108A, where the software application instance is associated with the user authentication management system 102. For example, the respective user may be attempting to log into a respective software application framework associated with an enterprise employing the user authentication management system 102 and, as such, the software application instance associated with the user authentication management system 102 may generate and/or cause transmission of a user authentication request based on the log in attempt.

As shown by operation 404, the apparatus 200 may include means, such as processor 202, memory 204, communications hardware 206, user authentication circuitry 208, audio data authentication circuitry 210, image data authentication circuitry 212, and/or the like, for facilitating an audio-visual authentication session. For example, in some embodiments, the user authentication circuitry 208 may be configured to initiate and/or facilitate, based on receiving a user authentication request from a client computing device (e.g., a client computing device 108A), an audio-visual authentication session, where the audio-visual authentication session may be configured to authenticate one or more of audio input data and/or image input data representative of a respective user.

In some embodiments, the user authentication circuitry 208 may be configured to authenticate the audio input data and/or the image input data representative of the user simultaneously during an audio-visual authentication session. In this regard, the user authentication circuitry 208 may be configured to cause the simultaneous capture of one or more portions of audio input data and/or image input data representative of the user by one or more hardware components associated with the client computing device (e.g., client computing device 108A) associated with the user during the audio-visual authentication session. Alternatively, in some embodiments, the user authentication circuitry 208 may be configured to cause the sequential capture of one or more portions of audio input data and/or image input data representative of the user (e.g., cause the capture audio input data before causing capture of image input data, or vice versa).

During an audio-visual authentication session, the user authentication circuitry 208 may be configured to generate, cause transmission of, and/or cause display of one or more interactive user interface elements on a user interface associated with the software application instance related to the user authentication management system 102 on a client computing device 108A, where the one or more interactive user interface elements are configured to initiate the capture of one or more portions of audio input data and/or image input data representative of a respective user. In this regard, the user authentication circuitry 208 may be configured to leverage the communications hardware 206 to access, control, direct, and/or otherwise manage one or more hardware components associated with the client computing device (e.g., client computing device 108A, ATM, security systems, and/or the like) associated with the respective user such as, for example, one or more audio capture devices (e.g., microphones), image capture devices (e.g., cameras), and/or electronic displays (e.g., touchscreens, user interfaces) of the client computing device associated with the user in order to facilitate the capture one or more portions of audio input data and/or image input data representative of the user.

For example, during a respective audio-visual authentication session, the user authentication circuitry 208 may cause display of one or more interactive user interface elements configured to prompt the respective user to speak such that an audio capture device associated with the client computing device (e.g., client computing device 108A) captures audio input data associated with the speaking voice of the respective user. Additionally, the user authentication circuitry 208 may cause display of one or more interactive user interface elements configured to prompt the respective user to sit, stand, and/or gesture within the field of view of a respective image capture device associated with the client computing device (e.g., client computing device 108A) in order to capture image input data representative of the respective user.

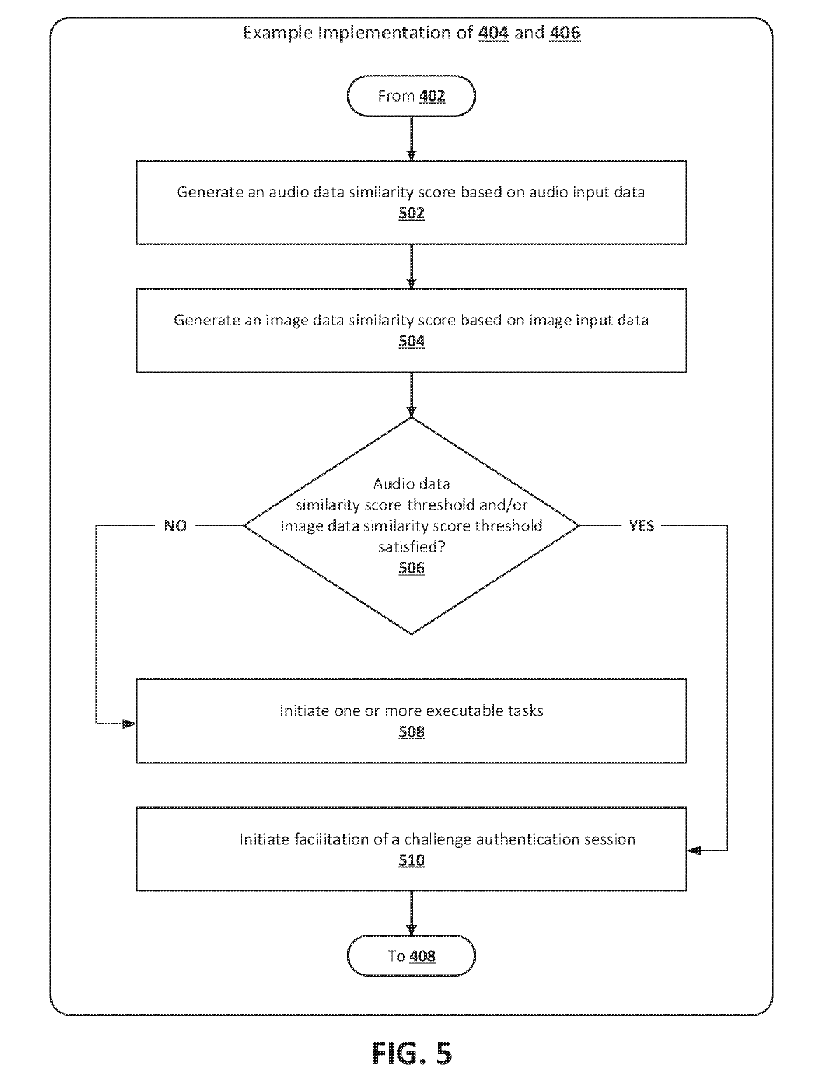

In some embodiments, the audio data authentication circuitry 210 and the image data authentication circuitry 212 may be configured to authenticate the respective audio input data and image input data representative of the respective user that is received during the audio-visual authentication session. For example, the audio data authentication circuitry 210 and the image data authentication circuitry 212 may be configured to execute a respective audio matching protocol and image matching protocol designed to generate audio data similarity scores and image data similarity scores for the respective audio input data and image input data. In this regard, the user authentication circuitry 208 may be configured to determine whether the audio input data and/or the image input data representative of the respective user are valid or invalid based in part on the respective audio data similarity scores and image data similarity scores. Further details related to the execution of operation 404 will be described below with reference to FIG. 5.

As shown by operation 406, the apparatus 200 may include means, such as processor 202, memory 204, user authentication circuitry 208, audio data authentication circuitry 210, image data authentication circuitry 212, AI modeling circuitry 216, and/or the like for determining whether the audio input data and/or the image input data representative of the respective user are valid or invalid.

In various embodiments, the user authentication circuitry 208 may be configured to determine, define, and/or configure one or more authentication thresholds for the user authentication management system 102. For example, the user authentication circuitry 208 may be configured to determine, define, and/or configure one or more of an audio data similarity score threshold and/or an image data similarity score threshold for use in determining whether one or more portions of audio input data and/or image input data representative of a user are valid (e.g., authentically represent the user). In this regard, the user authentication circuitry 208 may be configured to compare one or more audio data similarity scores and/or image data similarity scores generated based on one or more respective audio matching protocols and/or image matching protocols to a respective audio data similarity score threshold and/or image data similarity score threshold.

For example, the user authentication circuitry 208 may determine if an audio data similarity score (e.g., a numerical value or the like) satisfies an audio data similarity score threshold (e.g., a numerical value or the like). The audio data similarity score may satisfy the audio data similarity score threshold if the audio data similarity score is greater than or equal to the audio data similarity score threshold (e.g., to within an error value of ±1%, ±5%, or any other number). In other examples, the audio data similarity score (e.g., a numerical value or the like) may satisfy the audio data similarity score threshold (e.g., a numerical value or the like) if the audio data similarity score similarity score is less than or equal to the audio data similarity score threshold (e.g., to within an error value of ±1%, ±5%, or any other number). Additionally, the user authentication circuitry 208 may determine if an image data similarity score (e.g., a numerical value or the like) satisfies an image data similarity score threshold (e.g., a numerical value or the like) in a similar fashion as described above with regard to the audio data similarity score.

In this regard, the user authentication circuitry 208 may leverage the audio data authentication circuitry 210 and/or the image data authentication circuitry 212 to execute one or more respective audio matching protocols and/or image matching protocols in order to generate one or more respective audio data similarity scores and/or image data similarity scores based on one or more portions of audio input data and/or image input data received from a client computing device (e.g., client computing device 108A) during an audio-visual authentication session. Further details related to the execution of operation 406 will be described with reference to FIG. 5 below.

If, at operation 406, the user authentication circuitry 208 determines that an audio data similarity score and/or an image data similarity score fail to satisfy one or more of a respective audio data similarity score threshold and/or image data similarity score threshold, the user authentication circuitry 208 may be configured to revert to operation 404 of the flowchart 400. In this regard, the user authentication circuitry 208 may be configured to generate a new (e.g., second) audio-visual authentication session. In such examples, the new (e.g., second) audio-visual authentication session may be configured to facilitate the re-capture of one or more portions of audio input data and/or image input data representative of a user that failed to provide valid audio input data and/or valid image input data during an initial (e.g., first) audio-visual authentication session. Alternatively, if the user authentication circuitry 208 determines that the audio data similarity score and the image data similarity score both satisfy the audio data similarity score threshold and the image data similarity score threshold respectively, the user authentication circuitry 208 may be configured to proceed to operation 408 of the flowchart 400.

As shown by operation 408, the apparatus 200 may include means, such as processor 202, memory 204, communications hardware 206, user authentication circuitry 208, challenge data authentication circuitry 214, AI modeling circuitry 216, and/or the like, for facilitating a challenge authentication session. In some embodiments, a challenge authentication session is configured to capture at least a first user response to at least a first challenge question of one or more challenge questions dynamically generated by the AI modeling circuitry 216 (e.g., in conjunction with the user authentication model), where the first challenge question is characterized by a first degree of difficulty. In some embodiments, the user authentication circuitry 208 may be configured to initiate and/or facilitate the challenge authentication session in response to determining that the audio data similarity score associated with the audio input data and the image data similarity score associated with the image input data satisfy an audio data similarity score threshold and image data similarity score threshold respectively.

In various embodiments, a challenge authentication session may be configured to authenticate a user by facilitating the capture of one or more user responses to a series of challenge questions automatically generated by the AI modeling circuitry 216 (e.g., in conjunction with the user authentication model). In one or more embodiments, the series of challenge questions are generated by the AI modeling circuitry 216 (e.g., in conjunction with the user authentication model) based on a user persona associated with a respective user. The series of challenge questions may be scaled by the user authentication model such that the challenge questions range in difficulty, complexity, and/or specificity to better counteract suspected fraudulent activity (e.g., due to previous failed login attempts, long user response times).

In this regard, the user authentication circuitry 208 may be configured to leverage the communications hardware 206 to access, control, direct, and/or otherwise manage one or more hardware components associated with the client computing device (e.g., client computing device 108A) associated with the respective user such as, for example, one or more audio capture devices (e.g., microphones), image capture devices (e.g., cameras), and/or electronic displays (e.g., touchscreens, user interfaces) of the client computing device associated with the user in order to facilitate the capture one or more user responses to one or more challenge questions administered during a respective challenge authentication session.

For example, in various embodiments, the user authentication circuitry 208 may be configured to generate, cause transmission of, and/or cause display of one or more interactive user interface elements on a user interface associated with the software application instance related to the user authentication management system 102, where the one or more interactive user interface elements are associated with one or more respective challenge questions generated by the user authentication model. Additionally, the user authentication circuitry 208 may be configured to access one or more user responses to one or more respective challenge questions via the user interface associated with the software application instance. As a non-limiting example, the user authentication circuitry 208 may cause display of an interactive list of possible answers to a respective challenge question via the user interface, where the possible answers are selectable via the user interface. As another non-limiting example, the user authentication circuitry 208 may be configured to access one or more portions of text input data corresponding to a user response to a respective challenge question. As yet another non-limiting example, the user authentication circuitry 208 may be configured to prompt the input of audio input data and/or image input data associated with a user response to a respective challenge question.

As shown by operation 410, the apparatus 200 may include means, such as processor 202, memory 204, user authentication circuitry 208, challenge data authentication circuitry 214, AI modeling circuitry 216, and/or the like for determining whether a user response (e.g., the first user response) to a challenge question (e.g., the first challenge question) matches an expected response (e.g., a first expected response) to the challenge question. For example, the user authentication circuitry 208 may be configured to leverage the challenge data authentication circuitry 214 to determine whether the first user response to the first challenge question matches the first expected response to the first challenge question, where the first expected response to the first challenge question is generated by the AI modeling circuitry 216 (e.g., in conjunction with the user authentication model) based on the user persona associated with the respective user.

In this regard, in some embodiments, the challenge data authentication circuitry 214 may be configured to parse, analyze, and/or otherwise process one or more user responses received in response to one or more respective challenge questions administered during a respective challenge authentication session in order to determine if the one or more user responses correctly matches one or more expected responses associated with the one or more respective challenge questions. In a first example, the user authentication circuitry 208 may leverage the challenge data authentication circuitry 214 to determine if one or more portions of text input data associated with the first user response to the first challenge question accessed via the user interface of the software application instance matches the first expected response to the first challenge question. As another example, the user authentication circuitry 208 (e.g., in conjunction with the challenge data authentication circuitry 214 and/or the AI modeling circuitry 216) may be configured to determine if captured audio input data associated with the first user response to the first challenge question (e.g., a spoken user response captured by a client computing device 108A) matches the first expected response to the first challenge question.

Furthermore, as described herein, the challenge data authentication circuitry 214 may be configured to generate, aggregate, compile, and/or otherwise process one or more challenge question response metrics associated with a respective user. For example, the challenge data authentication circuitry 214 may generate one or more challenge question response metric data including, but not limited to, successful challenge question attempt data (e.g., data related to previously administered challenge questions that were answered correctly), unsuccessful challenge question attempt data (e.g., data related to previously administered challenge questions that were answered incorrectly), challenge question response time data (e.g., the time taken to answer respective challenge questions correctly or incorrectly, the average elapsed time between challenge questions), challenge authentication session completion time data, and/or the like for respective user.

In some embodiments, the user authentication circuitry 208 (e.g., in conjunction with the challenge data authentication circuitry 214) may initiate one or more action based in part on the one or more challenge question response metrics associated with a respective user. For example, the challenge data authentication circuitry 214 may determine that a user response to a respective challenge question has not been provided by a client computing device (e.g., client computing device 108A) associated with the respective user within a predetermined acceptable duration of time. For instance, in some embodiments, the user authentication management system 102 may be configured to wait a maximum of thirty seconds (e.g., or any other number of seconds) for a user response to be provided for a challenge question administered during a respective challenge authentication session. If the user authentication circuitry 208 (e.g., in conjunction with the challenge data authentication circuitry 214) determines that a user response has not been provided within the predetermined acceptable duration of time, the challenge data authentication circuitry 214 may interpret the challenge question as being incorrectly answered and, accordingly, update one or more challenge question response metrics associated with the respective user. Additionally or alternatively, if the user authentication circuitry 208 (e.g., in conjunction with the challenge data authentication circuitry 214) determines that a user response for a first challenge question associated with a first degree of difficulty has not been provided within the predetermined acceptable duration of time, the user authentication circuitry 208 (e.g., in conjunction with the challenge data authentication circuitry 214) may cause transmission of a second challenge question associated with a second degree of difficulty.

In this regard, at operation 410, if the user authentication circuitry 208 determines that the first user response to the first challenge question does not match the first expected response to the first challenge question, the user authentication circuitry 208 may be configured to proceed to operation 414 of the flowchart 400. However, if the user authentication circuitry 208 determines that the first user response to the first challenge question does match the first expected response to the first challenge question, the user authentication circuitry 208 may be configured to proceed to operation 412 of the flowchart 400.

As shown by operation 412, the apparatus 200 may include means, such as processor 202, memory 204, communications hardware 206, user authentication circuitry 208, and/or the like for granting access permissions to a client computing device (e.g., client computing device 108A) associated with the respective user, where the one or more access permissions enable the client computing device (e.g., client computing device 108A) to access a software application framework associated with a respective enterprise related to the user authentication management system 102. For example, in the event that the user authentication circuitry 208 determines that the audio input data and the image input data captured during a respective audio-visual authentication are valid and, further, that an appropriate number of user responses to a series of challenge questions administered during a challenge authentication session match an appropriate number of expected responses to the series of challenge questions, the user authentication circuitry 208 may grant one or more access permissions to a client computing device (e.g., client computing device 108A) associated with a respective user.

The one or more access permissions may enable the client computing device (e.g., client computing device 108A) to access a software application framework (e.g., via a user account) associated with a respective enterprise. In various embodiments, the one or more access permissions may comprise and/or may be associated with one or more digital tokens, digital certificates, computing device credentials (e.g., MAC addresses, IP addresses, network addresses), user credentials (e.g., user identifiers, user profile identifiers, user account identifiers, passwords, passcodes), and/or the like configured to enable the client computing device (e.g., client computing device 108A) to access the software application framework associated with the respective enterprise.

As shown by operation 414, the apparatus 200 may include means, such as processor 202, memory 204, communications hardware 206, user authentication circuitry 208, challenge data authentication circuitry 214, and/or the like for transmitting an additional challenge question (e.g., second challenge question) of the one or more challenge questions generated by the AI modeling circuitry 216 to the client computing device (e.g., client computing device 108A), where the additional challenge question (e.g., second challenge question) is characterized by an increased level of difficulty relative to the degree of difficulty associated with the preceding challenge question (e.g., a second degree of difficulty).

In various embodiments, if the user authentication circuitry 208 (e.g., in conjunction with the challenge data authentication circuitry 214) determines that a first user response fails to match a first expected response to a first challenge question of a series of challenge questions during a challenge authentication session, the user authentication circuitry 208 may be configured to cause transmission of a second challenge question of the series of challenge questions to the respective client computing device (e.g. client computing device 108A). In such embodiments, the second challenge question may be characterized by a second degree of difficulty where the second degree of difficulty is an increased level of difficulty relative to a first degree of difficulty associated with the first challenge question. In this regard, the user authentication circuitry 208 may leverage the challenge data authentication circuitry 214 to administer a series of challenge questions during a challenge authentication session, where each subsequent challenge question that is administered from the series of challenge questions is characterized by a relative increase in difficulty, complexity, and/or specificity in comparison to a previously administered challenge question.

As shown by operation 416, the apparatus 200 may include means, such as processor 202, memory 204, communications hardware 206, user authentication circuitry 208, challenge data authentication circuitry 214, AI modeling circuitry 216, and/or the like for determining whether a user response to the additional challenge question (e.g., second challenge question) matches an expected response to the additional challenge question. The user authentication circuitry 208 may determine whether the user response to the additional challenge question (e.g., second challenge question) matches the expected response in a same or similar manner as described herein with reference to operation 410.

If the user authentication circuitry 208 determines that the user response to the additional challenge question (e.g., second challenge question) does not match the expected response to the additional challenge question, the user authentication circuitry 208 may be configured to proceed to operation 420 of the flowchart 400. However, if the user authentication circuitry 208 determines that the user response to the additional challenge question (e.g., second challenge question) matches the expected response to the additional challenge question, the user authentication circuitry 208 may be configured to proceed to operation 418 of the flowchart 400.

As shown by operation 418, the apparatus 200 may include means, such as processor 202, memory 204, communications hardware 206, user authentication circuitry 208, and/or the like, for granting access permissions to a client computing device (e.g., client computing device 108A) associated with the respective user, where the one or more access permissions enable the client computing device (e.g., client computing device 108A) to access a software application framework associated with a respective enterprise related to the user authentication management system 102 in a similar manner as described with reference to operation 412.

As shown by operation 420, the apparatus 200 may include means, such as processor 202, memory 204, communications hardware 206, user authentication circuitry 208, challenge data authentication circuitry 214, and/or the like for determining whether a predetermined challenge question limit associated with the user authentication management system 102 has been met and/or exceeded.

In various embodiments, the challenge question limit may represent a maximum number of attempts that a respective user has to answer one or more challenge questions during a respective challenge authentication session. Furthermore, as described herein, the user authentication circuitry 208 may be configured to determine, define, and/or configure how many challenge questions of a series of challenge questions that must be answered correctly in order for a respective client computing device (e.g., client computing device 108A) to be granted access permissions for a particular software application framework. For example, in some embodiments, the user authentication circuitry 208 may require that only one challenge question of a series of challenge questions be answered correctly. Alternatively, in other example embodiments, the user authentication circuitry 208 may require that a majority of challenge questions of a series of challenge questions be answered correctly (e.g., two out of three challenge questions must be answered correctly). In still other example embodiments, the user authentication circuitry 208 may require that the amount of correctly answered challenge questions of a series of challenge questions must scale (e.g., increase) depending on the number of incorrectly answered challenge questions. As a non-limiting example of such embodiments, for every one challenge question that is answered incorrectly, two challenge questions must be answered correctly.

Additionally or alternatively, in various embodiments, the user authentication circuitry 208 may be configured to allow a predetermined amount of challenge question attempts for a respective challenge question. For example, in some embodiments, a user may get two attempts to provide a user response that matches an expected response to a first challenge question before the user authentication circuitry 208 administers a second challenge question associated with an increased level of difficulty.

In this regard, if the user authentication circuitry 208 determines that the predetermined challenge question limit has not been met and/or exceeded, or if the user authentication circuitry 208 determines that a user may still be able to respond successfully to a predetermined (e.g., acceptable) number of challenge questions of a series of challenge questions during a challenge authentication session, the user authentication circuitry 208 may be configured to revert to operation 414 of the flowchart 400 and cause the generation and/or transmission of an additional challenge question (e.g., a third challenge question) characterized by an increased level of difficulty, complexity, and/or specificity relative to the previously administered challenge question (e.g., the second challenge question). Alternatively, if the user authentication circuitry 208 determines that the predetermined challenge question limit has been met and/or exceeded, or if the user authentication circuitry 208 determines that a user has failed to respond successfully to a predetermined number of challenge questions of a series of challenge questions during a challenge authentication session, the user authentication circuitry 208 may be configured to proceed to operation 422 of the flowchart 400.

As shown by operation 422, the apparatus 200 may include means, such as processor 202, memory 204, communications hardware 206, user authentication circuitry 208, audio data authentication circuitry 210, image data authentication circuitry 212, challenge data authentication circuitry 214, AI modeling circuitry 216, and/or the like, for generating and causing transmission of a suspected fraudulent activity notification (e.g., via communications hardware 206) to one or more enterprise computing devices (e.g., enterprise computing devices 106A-106N) associated with the respective enterprise associated with the user authentication management system 102.

In this regard, if the user authentication circuitry 208 determines that a user has failed to respond successfully to a predetermined number of challenge questions of a series of challenge questions during a challenge authentication session, the user authentication circuitry 208 may be configured to generate a suspected fraudulent activity notification. The user authentication circuitry 208 may be further configured to cause transmission of the suspected fraudulent activity notification (e.g., via communications hardware 206) to one or more enterprise computing devices (e.g., enterprise computing devices 106A-106N) associated with a respective enterprise. In various embodiments, the suspected fraudulent activity notification may be configured as an email notification, a short message service (SMS) notification, a direct chat notification, an automated audio notification, and/or the like. Furthermore, in various embodiments, the user authentication circuitry 208 may be configured to identify one or more appropriate enterprise representatives (e.g., enterprise managers, administrators, IT support personnel) and cause transmission of the suspected fraudulent activity notification to the one or more enterprise computing devices (e.g., enterprise computing devices 106A-106N) associated with the one or more appropriate enterprise personnel.

As shown by operation 424, the apparatus 200 may include means, such as processor 202, memory 204, communications hardware 206, user authentication circuitry 208, audio data authentication circuitry 210, image data authentication circuitry 212, challenge data authentication circuitry 214, and/or the like for initiating one or more executable tasks in response to determining that a user has failed to respond successfully to a predetermined number of challenge questions of a series of challenge questions during a challenge authentication session. For example, in response to determining that a user has failed to respond successfully to a predetermined number of challenge questions of a series of challenge questions during a challenge authentication session, the user authentication circuitry 208 may be configured to initiate facilitation of a new audio-visual authentication session (e.g., a second audio-visual authentication session). In this regard, in some embodiments, if a user fails to successfully respond to the one or more challenge questions associated with a challenge authentication session, the user authentication circuitry 208 may re-initiate the one or more user authentication operations associated with a respective user authentication management system 102 such that the user authentication operations are repeated from the beginning.

Additionally or alternatively, in various embodiments, the one or more executable tasks may comprise locking the user out of an account and/or software application framework associated with a respective enterprise. For example, in response to determining that a user has failed to respond successfully to a predetermined number of challenge questions of a series of challenge questions during a challenge authentication session, the user authentication circuitry 208 may be configured to prohibit the user from making further attempts to access a user account, a user profile, sensitive data, software application framework and/or the like associated with the respective enterprise. In various embodiments, the user may be prohibited from making further user authentication attempts for a predetermined duration of time (e.g., a predefined number of minutes, hours, and/or the like).

Additionally or alternatively, in various embodiments, the one or more executable tasks may comprise alerting the user and/or an enterprise representative that one or more challenges questions were incorrectly answered and/or that one or more recent user authentication attempts have been fraudulent. For example, in response to determining that a user has failed to respond successfully to a predetermined number of challenge questions of a series of challenge questions during a challenge authentication session, the user authentication circuitry 208 may be configured to generate and/or cause transmission of one or more alerts (e.g., suspected fraudulent activity notifications) detailing one or more failed user authentication attempts, where the one or more alerts describe information related to the time, date, computing device, location, and/or information related to the challenge questions that were incorrectly answered. In various embodiments, the user authentication circuitry 208 may cause transmission of the one or more alerts to one or more enterprise computing devices (e.g., enterprise computing devices 106A-106N) and/or one or more client computing devices (e.g., client computing devices 108A-108N) in various formats (e.g., via SMS, email, phone, and/or the like).

Turning now to FIG. 5, example operations are shown for facilitating an audio-visual authentication session. As described herein, FIG. 5 illustrates some example implementations of operations 404-406 described herein with reference to FIGS. 4A-4B.

As shown by operation 502, the apparatus 200 may include means, such as processor 202, memory 204, user authentication circuitry 208, audio data authentication circuitry 210, and/or AI modeling circuitry 216, and/or the like, for generating an audio data similarity score based on audio input data representative of a user captured during a respective audio-visual authentication session. In some embodiments, the audio data authentication circuitry 210 generates the audio data similarity score as a result of executing an audio matching protocol configured to authenticate, at least in part, a respective user.

In one or more embodiments, the audio data authentication circuitry 210 may be configured to extract various audio features from audio input data representative of a user received during facilitation of an audio-visual authentication session. For example, the audio data authentication circuitry 210 may extract, identify, classify, and/or otherwise determine one or more portions of acoustic feature data (e.g., timbre, pitch, fluctuation pattern data), valence data (e.g., whether a portion of the audio input data is related to a positive or negative emotion), arousal data (e.g., how excited or apathetic a user may be), dominance (e.g., how dominant or submissive a user may be), intensity data (e.g., volume data, gain data), intonation data, speech rate data, mel-frequency cepstral coefficient (MFCC) data, and/or the like from the audio input data. The aforementioned audio features extracted from the audio input data may be used by the audio data authentication circuitry 210 in order to authenticate the identity of the particular user that generated the audio input data.

In various embodiments, the audio matching protocol may comprise one or more operations configured to compare a plurality of audio features associated with the audio input data to a plurality of audio features associated with one or more portions of stored audio data associated the respective user. In various embodiments, the one or more portions of stored audio data may include, but are not limited to, user submitted audio input data received during a user authentication model training session (e.g., user-provided audio input data captured from the user while speaking for a predefined duration of time, reading from a script, and/or the like during a software application instance setup and/or configuration process), previously validated audio data (e.g., audio input data classified as validated during a previous audio-visual authentication session), synthetic audio data generated by the user authentication model based on a user persona associated with the respective user, and/or any relevant audio data generated by, captured from, and/or received from the respective user. In some examples, the plurality of audio features associated with the stored audio data related to the respective user may characterize a speaking voice of the respective user and, as such, may be utilized by audio data authentication circuitry 210 to authenticate (e.g., verify) that the audio input data was indeed generated by the respective user during an audio-visual authentication session.

In some embodiments, the audio data authentication circuitry 210 may be configured to generate an audio data similarity score as a result of executing the audio matching protocol. For example, based on the comparison of the extracted audio features associated with the audio input data representative of the user to various audio features associated with the stored audio data related to the user, the audio data authentication circuitry 210 may generate an audio data similarity score associated with a value (e.g., a numerical value, a percentage value) used to describe a degree to which the audio input data matches the stored audio data. For example, in various embodiments, the audio data authentication circuitry 210 may determine that the more extracted features of the audio input data that match the audio features of the stored audio data representative of the respective user, the higher the relative audio data similarity score will be.

Furthermore, in various examples, audio data authentication circuitry 210 may leverage the AI modeling circuitry 216 in order to apply one or more AI-based audio feature matching techniques, NLP techniques, speech recognition techniques, and/or the like to determine an audio data similarity score during the facilitation of an audio-visual authentication session. Additionally or alternatively, the audio data authentication circuitry 210 may work in conjunction with the user authentication circuitry 208 to classify one or more portions of audio input data associated with a user as validated audio data in response to determining that the corresponding audio data similarity score satisfies a predetermined audio data similarity score threshold.

Additionally, as described herein, a respective user (e.g., a primary user) with various accessibility needs may authorize a secondary user (e.g., a trusted user) to complete various user authentication operations on behalf of the respective user. In this regard, the audio data authentication circuitry 210 may be configured to authenticate the respective user by applying the same techniques described above with regard to audio input data generated by the secondary user. As a non-limiting example, a respective user with various speech impairments may be associated with a secondary user (e.g., a personal healthcare aide) who is authorized to complete one or more of the user authentication operations associated with an audio-visual authentication session. In this particular example, the secondary user may generate and/or otherwise provide audio input data (e.g., by speaking in their own voice) on behalf of the respective user (e.g., the primary user). As such, the audio data authentication circuitry 210 may be configured to execute the audio matching protocol as described above based on the audio input data from the secondary user in order to authenticate the respective user (e.g., the primary user).

As shown by operation 504, the apparatus 200 may include means, such as processor 202, memory 204, user authentication circuitry 208, image data authentication circuitry 212, and/or AI modeling circuitry 216, and/or the like for generating an image data similarity score based on image input data representative of a user captured during a respective audio-visual authentication session. In some embodiments, the image data authentication circuitry 212 generates the image data similarity score as a result of executing an image matching protocol configured to authenticate, at least in part, a respective user.

In one or more embodiments, the image data authentication circuitry 212 may be configured to extract various image features from image input data representative of a user during the facilitation of an audio-visual authentication session. For example, the image data authentication circuitry 212 may extract, identify, classify, and/or otherwise determine one or more portions of image feature data including, but not limited to, edge data, corner data, blob data, ridge data, and/or the like from the image input data. Additionally or alternatively, the image data authentication circuitry 212 may extract, identify, classify, and/or otherwise determine one or more portions of facial feature data, eye movement data, facial expression data, body posture data, body gesture data, hand gesture data, sign language data, and/or the like from the image input data. The aforementioned image features extracted from the image input data may be used by the image data authentication circuitry 212 in order to authenticate the identity of the particular user associated with the image input data.

In various embodiments, the image matching protocol may comprise one or more operations configured to compare a plurality of image features associated with the image input data to a plurality of image features associated with one or more portions of stored image data associated the respective user. In various embodiments, the one or more portions of stored image data may include, but are not limited to, user submitted image input data received during a user authentication model training session (e.g., user-provided image input data captured from the user during a software application instance setup and/or configuration process), previously validated image data (e.g., image input data classified as validated during a previous audio-visual authentication session), synthetic image data generated by the user authentication model based on a user persona associated with the respective user, and/or any relevant image data generated by, captured from, and/or received from the respective user. In some examples, the plurality of image features associated with the stored image data related to the respective user may characterize one or more physical features of the respective user including, but not limited to, facial features (e.g., eyes, nose, mouth, ears, chin), eye features (e.g., shape, color, width), head features (e.g., size, shape), hair features (e.g., color, length), body composition features (e.g., body mass index, height, weight, demographic data, sex and/or gender data), mannerism features (e.g., body language features, body gesture features, ticks), and/or the like. As such, the one or more physical features of the respective user may be utilized by image data authentication circuitry 212 to authenticate (e.g., verify) that the image input data was indeed generated by the respective user during an audio-visual authentication session.

In some embodiments, the image data authentication circuitry 212 may be configured to generate an image data similarity score as a result of executing the image matching protocol. For example, based on the comparison of the extracted image features associated with the image input data representative of the user to various image features associated with the stored image data related to the user, the image data authentication circuitry 212 may generate an image data similarity score associated with a value (e.g., a numerical value, a percentage value) used to describe a degree to which the image input data matches the stored image data. For example, in various embodiments, the image data authentication circuitry 212 may determine that the more extracted features of the image input data that match the image features of the stored image data representative of the respective user, the higher the relative image data similarity score will be.

In various examples, image data authentication circuitry 212 may leverage the AI modeling circuitry 216 in order to apply one or more AI-based image feature matching techniques, machine vision techniques, facial recognition techniques, body language interpretation techniques, and/or the like to determine an image data similarity score during the facilitation of an audio-visual authentication session. Additionally or alternatively, the image data authentication circuitry 212 may work in conjunction with the user authentication circuitry 208 to classify one or more portions of image input data associated with a user as validated image data in response to determining that the corresponding image data similarity score satisfies a predetermined image data similarity score threshold.

Furthermore, as described herein, a respective user (e.g., a primary user) with various accessibility needs may authorize a secondary user (e.g., a trusted user) to complete various user authentication operations on behalf of the respective user. In this regard, the image data authentication circuitry 212 may be configured to authenticate the respective user by applying the same techniques described above with regard to image input data generated by the secondary user. As a non-limiting example, a respective user with various accessibility needs may be associated with a secondary user (e.g., a caretaker) who is authorized to complete one or more of the user authentication operations associated with an audio-visual authentication session. In this particular example, the secondary user may generate and/or otherwise provide image input data in conjunction with, or on behalf of, the respective user (e.g., the primary user). For instance, the secondary user may be in the same image frame and/or video as the respective user (e.g., the primary user) captured during a respective audio-visual authentication session, and the image data authentication circuitry 212 may be configured to authenticate the various images features associated with the secondary user in addition to the respective user (e.g., the primary user). Additionally or alternatively, the second user may be authorized to provide image input data that does not include the respective user (e.g., the primary user) during the respective audio-visual authentication session. In this regard, the image data authentication circuitry 212 may be configured to execute the image matching protocol as described above based on various image input data associated with the secondary user in order to authenticate the respective user (e.g., the primary user).

As shown by operation 506, the apparatus 200 may include means, such as processor 202, memory 204, user authentication circuitry 208, and/or the like for determining whether the audio data similarity score and/or the image data similarity score satisfy an audio data similarity score threshold and an image data similarity score threshold respectively. In this regard, the user authentication circuitry 208 may be configured to compare the audio data similarity score and/or the image data similarity score generated based on the respective audio matching protocol and/or image matching protocol to a respective audio data similarity score threshold and/or image data similarity score threshold.

For example, the user authentication circuitry 208 may determine if an audio data similarity score (e.g., a numerical value or the like) satisfies an audio data similarity score threshold (e.g., a numerical value or the like). The audio data similarity score may satisfy the audio data similarity score threshold if the audio data similarity score is greater than or equal to the audio data similarity score threshold (e.g., to within an error value of ±1%, ±5%, or any other number). In other examples, the audio data similarity score (e.g., a numerical value or the like) may satisfy the audio data similarity score threshold (e.g., a numerical value or the like) if the audio data similarity score similarity score is less than or equal to the audio data similarity score threshold (e.g., to within an error value of ±1%, ±5%, or any other number). Additionally, the user authentication circuitry 208 may determine if an image data similarity score (e.g., a numerical value or the like) satisfies an image data similarity score threshold (e.g., a numerical value or the like) in a similar fashion as described above with regard to the audio data similarity score.

In various embodiments, if the user authentication circuitry 208 determines that one or more of the audio data similarity score and/or the image data similarity score fail to satisfy the respective audio data similarity score threshold and/or image data similarity score threshold, the user authentication circuitry 208 may proceed to operation 508. Alternatively, if the user authentication circuitry 208 determines that both the audio data similarity score and the image data similarity score satisfy the respective audio data similarity score threshold and image data similarity score threshold, the user authentication circuitry 208 may proceed to operation 510.

It will be appreciated that, in various embodiments, the user authentication management system 102 may be configured to override, enable, disable, and/or reconfigure one or more hardware components associated with a client computing device (e.g., client computing device 108A) and/or an enterprise computing device (e.g., enterprise computing device 106A). Additionally or alternatively, in some embodiments, the user authentication management system 102 may be configured to override, enable, disable, and/or reconfigure one or more of the various features of the user authentication management system 102. For example, in various examples, a particular client computing device (e.g., a client computing device 108A) may not have an image capturing device (e.g., a camera) or an audio capturing device (e.g., a microphone). As a non-limiting example, in an embodiment in which the particular client computing device (e.g., a client computing device 108A) is configured as an ATM, the particular client computing device may not have an audio capture device (e.g., a microphone). Alternatively, in an embodiment in which the particular client computing device (e.g., a client computing device 108A) is configured as an ATM, various hardware components of the particular client computing device may be broken, damaged, and/or malfunctioning. In such scenarios, the user authentication management system 102 may be configured to override, enable, disable, and/or reconfigure one or more hardware components (e.g., a broken microphone, a malfunctioning camera) such that the various user authentication operations described herein may still be executed in part and will still enable a user to be authenticated and/or access the intended user account, user profile, software application framework, and/or the like.

Furthermore, as described herein, the user authentication management system 102 may be configured to accommodate various users with technological accessibility needs, medical conditions, and/or the like. In this regard, the user authentication management system 102 may be configured to override, enable, disable, and/or reconfigure one or more of the various features of the user authentication management system 102 in order to accommodate the various technological accessibility needs and/or medical conditions of a respective user. As a non-limiting example, a respective user may have a medical condition that prevents the user from speaking. As such, the user authentication management system 102 may be configured to authenticate the user based solely on image input data representative of the user captured during a respective audio-visual authentications session. In such an example, the user authentication management system 102 may be configured to override, enable, disable, and/or reconfigure one or more features related to the capture and/or processing of audio input data representative of the user.

As shown by operation 508, the apparatus 200 may include means, such as processor 202, memory 204, user authentication circuitry 208, audio data authentication circuitry 210, image data authentication circuitry 212, and/or the like for initiating one or more executable tasks in response to determining that one or more of the audio data similarity score and/or the image data similarity score fail to satisfy the respective audio data similarity score threshold and/or image data similarity score threshold. For example, in response to determining that a user has failed to provide valid audio input data and/or image input data during an audio-visual authentication session, the user authentication circuitry 208 may be configured to initiate facilitation of a new audio-visual authentication session (e.g., a second audio-visual authentication session). In this regard, in some embodiments, if one or more of the audio data similarity score and/or the image data similarity score fail to satisfy the respective audio data similarity score threshold and/or image data similarity score threshold, the user authentication circuitry 208 may re-initiate the one or more user authentication operations associated with a respective user authentication management system 102 such that the user authentication operations are repeated from the beginning.

Additionally or alternatively, in various embodiments, the one or more executable tasks may comprise locking the user out of an account and/or software application framework associated with a respective enterprise. For example, in response to determining that one or more of the audio data similarity score and/or the image data similarity score fail to satisfy the respective audio data similarity score threshold and/or image data similarity score threshold, the user authentication circuitry 208 may be configured to prohibit the user from making further attempts to access a user account, a user profile, sensitive data, software application framework and/or the like associated with the respective enterprise. In various embodiments, the user may be prohibited from making further user authentication attempts for a predetermined duration of time (e.g., a predefined number of minutes, hours, and/or the like).

Additionally or alternatively, in various embodiments, the one or more executable tasks may comprise alerting the user and/or an enterprise representative that one or more of the audio data similarity score and/or the image data similarity score failed to satisfy the respective audio data similarity score threshold and/or image data similarity score threshold, and/or that one or more recent user authentication attempts have been fraudulent. For example, in response to determining that one or more of the audio data similarity score and/or the image data similarity score failed to satisfy the respective audio data similarity score threshold and/or image data similarity score threshold, the user authentication circuitry 208 may be configured to generate and/or cause transmission of one or more alerts (e.g., suspected fraudulent activity notifications) detailing one or more failed user authentication attempts, where the one or more alerts describe information related to the time, date, computing device, location, and/or information related to the invalid audio input data and/or invalid image input data. In various embodiments, the user authentication circuitry 208 may cause transmission of the one or more alerts to one or more enterprise computing devices (e.g., enterprise computing devices 106A-106N) and/or one or more client computing devices (e.g., client computing devices 108A-108N) in various formats (e.g., via SMS, email, phone, and/or the like).

Furthermore, in some embodiments, the user authentication circuitry 208 may determine that an allowable number of audio-visual authentication sessions have been exceeded for a predefined duration of time. As a non-limiting example, if the user authentication circuitry 208 has facilitated three (3) audio-visual authentication sessions within a predefined duration of time (e.g., 1 minute, two minutes, five minutes) without receiving valid audio input data and/or image input data from a respective client computing device 108A, the user authentication circuitry 208 may prohibit (e.g., deny, lock out, block) the respective client computing device 108A from executing further attempts to access a software application framework associated with a respective enterprise.

Additionally, in response to determining that an allowable number of audio-visual authentication sessions has been exceeded for a predefined duration of time, the user authentication circuitry 208 may be configured to generate and/or cause transmission of one or more suspected fraudulent activity notifications to one or more enterprise computing devices (e.g., one or more enterprise computing devices 106A-106N) associated with the respective enterprise. In various embodiments, the suspected fraudulent activity notification may be configured as an email notification, an SMS notification, a direct chat notification, an automated audio notification, and/or the like.

As shown by operation 510, the apparatus 200 may include means, such as processor 202, memory 204, user authentication circuitry 208, challenge data authentication circuitry 214, AI modeling circuitry 216, and/or the like, for initiating the facilitation of a challenge authentication session. For example, in response to determining that the audio data similarity score and the image data similarity score do satisfy a respective audio data similarity score threshold and image data similarity score threshold, the user authentication circuitry 208 may be configured to initiate and/or facilitate a challenge authentication session as described herein with reference to operation 414 of FIG. 4B. As described herein, a challenge authentication session may be configured to authenticate a user by facilitating the capture of one or more user responses to a series of challenge questions automatically generated by a user authentication model.

Additionally, in response to determining that an audio data similarity score and an image data similarity score do satisfy a respective audio data similarity score threshold and image data similarity score threshold, the user authentication circuitry 208 may be configured to classify the corresponding audio input data and corresponding image input data as validated audio data and validated image data respectively. Furthermore, the user authentication circuitry 208 may cause the storage of the validated audio data and the validated image data in a storage device associated with the user authentication management system 102. In various embodiments, the stored validated audio data and the stored validated image data may be used to update one or more portions of user data (e.g., user profile data, user persona data, and/or other user data) associated with respective user and used to facilitate the various operations described herein. For example, stored and validated audio data and/or stored and validated image data may be utilized by the AI modeling circuitry 216 to generate one or more respective portions of synthetic audio data and/or synthetic image data representative of the user, where the synthetic audio data and/or synthetic image data may be used in part to authenticate the user during subsequent audio-visual authentication sessions.

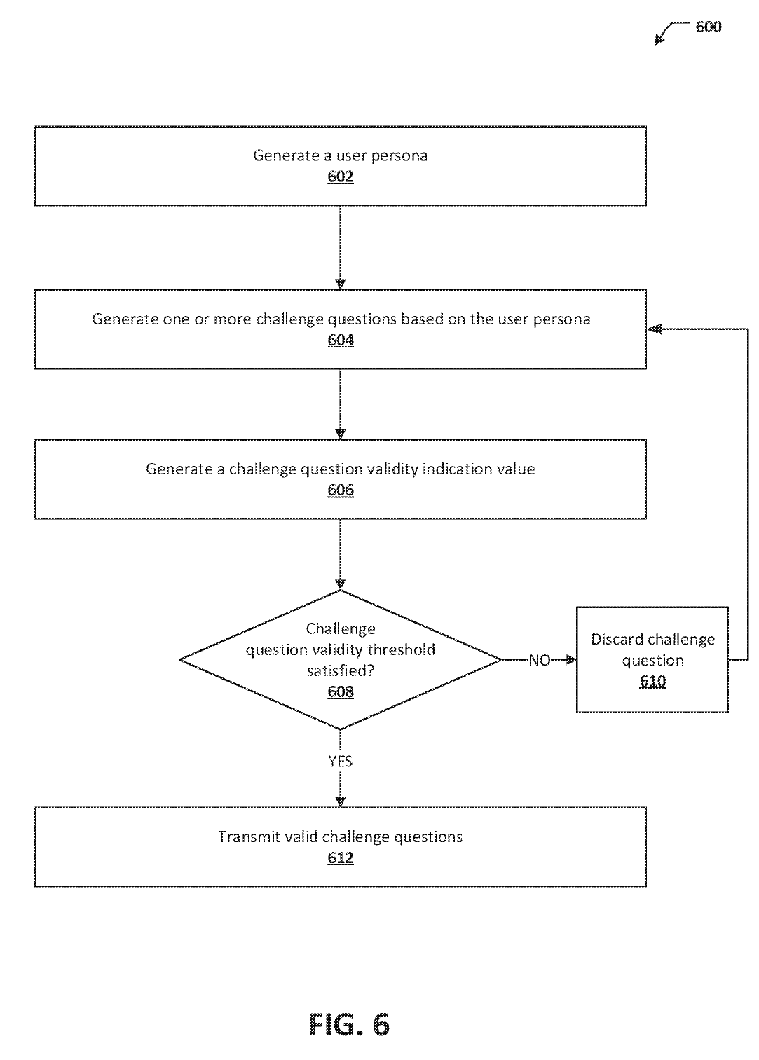

Turning next to FIG. 6, flowchart 600 illustrates example operations for generating customized challenge questions for a user based on an AI-generated user persona.

As shown by operation 602, the apparatus 200 may include means, such as processor 202, memory 204, and/or AI modeling circuitry 216, and/or the like, for generating a user persona for a respective user. For example, in various embodiments, the AI modeling circuitry 216 may be configured to leverage a user authentication model to generate a user persona for a respective user based on various types of data representative of the user stored in a storage device associated with the user authentication management system 102. A user persona may be a digital representation of the respective user and may be associated with a user profile and/or user account managed by a particular enterprise employing the user authentication management system 102.

In some embodiments, the data representative of the user utilized to generate a respective user persona may be aggregated in part from various external data sources outside of a particular enterprise employing the user authentication management system 102. The data representative of the user utilized to generate a respective user persona may include, but is not limited to, biological data (e.g., age, height, weight, blood type, eye color), personal data (e.g., demographic data, residential address, work address, phone numbers, family members, contacts), online activity data (e.g., social media data, web browser history, search inquiry data), offline activity data (e.g., lifestyle data, hobby data, exercise habits, visited restaurants, eating patterns, visited locations, travel data), financial activity data (e.g., online banking history, mobile banking history, money withdrawals, money deposits, money transfers, credit card transactions, failed login attempts, purchases) accessibility data (e.g., personal health data, secondary user data (e.g., health aide profile data, caretaker profile data), communication needs, technological accessibility needs), challenge question response metrics (e.g., successful challenge question attempt data, unsuccessful challenge question attempt data, challenge question response time data), historical user authentication data, validated audio data (e.g., recorded and/or stored audio input data associated with successful user authentication attempts), validated image data (e.g., recorded and/or stored image input data associated with successful user authentication attempts), synthetic audio data (e.g., generated by the user authentication model), and/or synthetic image data (e.g., generated by the user authentication model) representative of the user.

As described herein, the AI modeling circuitry 216 may be configured to leverage a user authentication model to generate various synthetic data (e.g., synthetic audio data, synthetic image data, and/or the like) based on a user persona associated with a respective user. In various embodiments, the AI modeling circuitry 216 may utilize the synthetic data to train and/or re-train the user authentication model to defend against various fraudulent user authentication attempts. For instance, the user authentication model may be configured to generate synthetic audio data and/or synthetic image data representative of the user based on their user persona in order to represent yet unknown scenarios that can be used to better authenticate future audio inputs and/or image inputs. In this manner, the user authentication model may better anticipate fraudulent audio input and/or image input scenarios and/or counteract computer-generated threats. In various embodiments, the various synthetic data (e.g., synthetic audio data, synthetic image data, and/or the like) may be stored in association with, or as a part of, a user persona associated with a respective user.

In some embodiments, the user authentication model may generate synthetic image data representative of the user that may characterize variations in the appearance and/or location of the user. For example, the synthetic image data may include a plurality of AI-generated image data and/or AI-generated video data representative of the user comprising variations of facial expressions of the user, variations of hair styles of the user, variations of clothes and/or accessories of the user, variations of body postures and/or gestures of the user, and/or the like. Additionally or alternatively, the synthetic image data may include a plurality of AI-generated image data and/or AI-generated video data representative of the user comprising variations of a physical environment of the user. For example, the synthetic image data may include variations in the setting (e.g., indoor setting, outdoor setting), background (e.g., natural features, buildings), atmosphere (e.g., time of day, time of year), and/or weather (e.g., cloudy, snowy, rainy, sunny) of the physical environment of the user.

In some embodiments, the variations in the appearance and/or location of the user comprised in the synthetic image data may be likely (e.g., probable) variations and/or unlikely (e.g., improbable) variations based on the respective user persona corresponding to the user, and may be used to make the user authentication model more robust. As a non-limiting example, the user authentication model may be updated (e.g., re-trained) based on synthetic image data comprising likely variations of the user in which some portions of the synthetic image data characterize the user as having facial hair (or a particular facial hair style), and some portions of the synthetic image data characterize the user as having no facial hair. In such an example, when the user authentication model is subsequently employed during an audio-visual authentication session to facilitate the authentication of image input data representative of the user, the user authentication model may not flag the image input data as invalid if the user authentication model detects a change in the user’s facial hair (e.g., if the user has shaved, grown a goatee).

Additionally, in some embodiments, the user authentication model may generate synthetic audio data representative of the user that may characterize variations in the speaking voice and/or location of the user. For example, the synthetic audio data may include a plurality of AI-generated audio data representative of the user comprising variations in the tone, inflection, emotion, pace, and/or other acoustic features associated with the speaking voice of the user. Additionally or alternatively, the synthetic audio data may include a plurality of AI-generated audio data representative of the user comprising variations of the background noise of a physical environment of the user. For example, the synthetic audio data may include variations in the setting (e.g., indoor setting, outdoor setting), background (e.g., various spoken languages, crowds of people, street noise), and/or weather (e.g., windy, rainy) of the physical environment of the user.

In some embodiments, the variations in the speaking voice and/or location of the user comprised in the synthetic audio data may be likely (e.g., probable) variations and/or unlikely (e.g., improbable) variations based on the respective user persona corresponding to the user, and may be used to make the user authentication model more robust. As a non-limiting example, the user authentication model may be updated (e.g., re-trained) based on synthetic audio data comprising unlikely variations of the location of the user in which some portions of the synthetic audio data characterize the user as being near one or more people speaking in a different language than the user usually speaks or than the user is usually surrounded by. In such an example, when the user authentication model is subsequently employed during an audio-visual authentication session to facilitate the authentication of audio input data representative of the user, the user authentication model may flag the audio input data as invalid if the user authentication model detects background noise (e.g., background voices speaking in an unexpected language) that is unlikely given the usual habits of the user.

In this regard, the AI modeling circuitry 216 may leverage the user authentication model to generate various synthetic image data and/or synthetic audio data (separately or in combination) that represents various scenarios that have not yet occurred with respect to a user based on the user’s respective user persona. For example, the AI modeling circuitry 216 may employ the user authentication model to generate various adverse scenarios based on synthetic image data and/or synthetic audio data in order to re-train and/or update the user authentication model to better mitigate fraudulent user authentication attempts. As a non-limiting example, the AI modeling circuitry 216 may cause the generation of synthetic image data and/or synthetic audio data associated with a potential (e.g., yet unexperienced) adverse scenario in which a bad actor (e.g., a thief) is forcing the user to log into a client computing device (e.g., client computing device 108A). In such an example, the synthetic image data and/or synthetic audio data associated with the potential adverse scenario may depict the bad actor in the background of an image of the user.

Additionally, as described herein, the user authentication management system 102 may be configured to enable a respective user (e.g., a primary user) with various accessibility needs to allow a secondary user (e.g., a trusted user, caretaker, personal healthcare aide) to complete one or more user authentication operations (in total, or in part) on behalf of the respective user. For example, a secondary user associated with the respective user may be authorized to provide, generate, and/or otherwise be associated with one or more portions of audio input data, image input data, and/or user response data to be utilized by the user authentication management system 102 to authenticate the respective user. In this regard, the AI modeling circuitry 216 may leverage the user authentication model to generate various synthetic image data and/or synthetic audio data (separately or in combination) for the respective user (e.g., the primary user) that comprises synthetic image data and/or synthetic audio data representative of the secondary user associated with the respective user (e.g., the primary user). In one or more embodiments, the synthetic image data and/or synthetic audio data representative of the secondary user may be generated based in part on one or more portions of accessibility data (e.g., personal health data, secondary user data (e.g., health aide profile data, caretaker profile data), communication needs, technological accessibility needs) associated with the user persona corresponding to the respective user (e.g., the primary user).

As a non-limiting example, the AI modeling circuitry 216 may leverage the user authentication model to generate synthetic image data and/or synthetic audio data comprising variations in the appearance, speaking voice, and/or location of the secondary user (with or without featuring the respective primary user) in order to represent various scenarios that have not yet occurred with respect to the respective user and/or the secondary user. In this manner, the AI modeling circuitry 216 may ensure that the user authentication model is trained to correctly authenticate both the respective user (e.g., the primary user) and the secondary user in subsequent audio-visual authentication sessions.

As shown by operation 604, the apparatus 200 may include means, such as processor 202, memory 204, AI modeling circuitry 216, and/or the like, for generating one or more challenge questions based on the user persona associated with the respective user. As described herein, the AI modeling circuitry 216 may be configured to leverage the user authentication model to generate one or more customized challenge questions to be administered to a respective user during a challenge authentication session of a user authentication process.

In this regard, the one or more customized challenge questions generated based off the user persona corresponding to the respective user may be questions regarding specific details, data points, values, scenarios, circumstances, events, and/or the like associated with one or more portions of user data used by the AI modeling circuitry 216 to generate the user persona. As a non-limiting example, “What restaurant did you eat at last night?” may be a challenge question generated based on the financial activity (e.g., credit card transaction data) associated with a particular user persona. As another non-limiting example, “How many online purchases did you make on www.XYZ-store.com this week?” may be another challenge question generated based on the financial activity associated with a particular user persona. As yet another non-limiting example, “What time did you exercise on Monday?” may be a challenge question generated based on the offline activity (e.g., exercise habit data, lifestyle data) associated with a particular user persona. In some embodiments, depending on the relative difficulty, complexity, and/or specificity of a respective challenge question, the user authentication model may generate a challenge question based on a combination of data associated with a particular user persona. As a non-limiting example, “How old were you when you visited Chicago this year?” may be a challenge question generated based on a combination of biological data (e.g., birthdate data, age data) and online activity data (e.g., social media posts about a trip to Chicago) associated with a particular user persona.

In this regard, the one or more customized challenge questions may be generated based on the user persona associated with the respective user and may be scaled by the user authentication model such that the customized challenge questions range in difficulty, complexity, and/or specificity. For example, if a user fails to successfully answer a first challenge question associated with a first degree of difficulty (e.g., a low degree of difficulty) during a respective challenge authentication session, a second challenge question associated with a second degree of difficulty (e.g., a higher degree of difficulty) may be administered. In this regard, the AI modeling circuitry 216 may be configured to leverage the user authentication model to generate a series of customized challenge questions, wherein each subsequent challenge question in the series of customized challenge questions is associated with a relative increase in the degree of difficulty, complexity, and/or specificity in comparison to the one or more prior challenge questions in the series of challenge questions.

Furthermore, the AI modeling circuitry 216 may leverage the user authentication model to generate one or more expected responses to the series of customized challenge questions. In some embodiments, an expected response to a respective challenge question may be associated with one or more of a numerical value, a text string (e.g., a word or phrase), a selection of an interactive user interface element (e.g., a radio button, checkbox), and/or the like that is to be provided by a client computing device (e.g., client computing device 108A) associated with a respective user.

As shown by operation 606, the apparatus 200 may include means, such as processor 202, memory 204, AI modeling circuitry 216, and/or the like for generating, for each challenge question of the one or more challenge questions, a challenge question validity indication value that indicates whether a respective challenge question is a valid challenge question. Because a series of customized challenge questions to be administered during a challenge authentication session may be generated based on various user persona data associated with a respective user (e.g., including user persona data that originates from data sources that are external to a particular enterprise employing the user authentication management system 102), the AI modeling circuitry 216 is configured to execute a challenge question validity protocol to ensure that the challenge questions are valid. In this regard, the AI modeling circuitry 216 may be configured to generate, for each challenge question of one or more challenge questions to be administered during a respective challenge authentication session, a challenge question validity indication value.

In various embodiments, the challenge question validity indication value may be any numerical value within a predefined numerical range (e.g., a number between zero (0) and one (1)). Additionally or alternatively, the challenge question validity indication value may be a binary value (e.g., represented as a zero (0) or a one (1)). In one or more embodiments, the challenge question validity indication value indicates whether a respective challenge question satisfies one or more of an open-ended question probability threshold or a subject validity probability threshold. As such, the AI modeling circuitry 216 may generate and/or assign an open-ended question probability and/or a subject validity probability to the respective challenge question.

In various embodiments, the open-ended question probability may be numerical value within a predefined numerical range (e.g., a number between zero (0) and one (1)) that indicates the probability that a respective challenge question is open-ended. In some embodiments, a challenge question may be classified as open-ended if there may be more than one expected response (e.g., correct response) to the challenge question. As a non-limiting example, the user authentication model may generate a challenge question based on various financial activity data associated with a respective user that occurred during the previous night. In such an example, the user may have purchased one or more items while first visiting a coffee shop, then visiting a clothing store, and finally visiting a movie theater. As such, in this example, the AI modeling circuitry 216 may assign an open-ended question probability with a high relative value (e.g., 0.75, 0.8) to the challenge question “What establishment did you visit last night?” as the challenge question has three potential expected responses (e.g., the coffee shop, the clothing store, and the movie theater). Alternatively and in keeping with the above example, the AI modeling circuitry 216 may assign an open-ended question probability with a low relative value (e.g., 0.1, 0.2) to the challenge question “What establishment did you visit first last night?” as the challenge question has only one potential expected response (e.g., the coffee shop).

As described herein, the AI modeling circuitry 216 may also generate and/or assign a subject validity probability to a respective challenge question. In various embodiments, the subject validity probability may be numerical value within a predefined numerical range (e.g., a number between zero (0) and one (1)) that indicates the probability that a respective subject (e.g., the user) is present in the challenge question (e.g., was present at a time and/or during an activity associated with the challenge question). As a non-limiting example, the user authentication model may generate a challenge question based on various online activity (e.g., social media activity associated with the platform X, formerly known as Twitter) associated with a respective user. In such an example, the user authentication model may generate the challenge question “Which one of your followers on X posted about the non-profit charity ABC yesterday?” In this example, the AI modeling circuitry 216 may assign a subject validity probability with a low relative value (e.g., 0.2, 0.3) to the challenge question because there may be only a small chance that the subject (e.g., the respective user) viewed the post about the non-profit charity written by a particular follower (e.g., social media “friend”) of the subject. Alternatively and in keeping with the above example, the AI modeling circuitry 216 may assign a subject validity probability with a high relative value (e.g., 0.82, 0.9) to the challenge question “What non-profit charity did you post about yesterday?” (e.g., given that the user did indeed post about a particular non-profit charity the day before) as the subject (e.g., the respective user) is central to the challenge question.

As shown by operation 608, the apparatus 200 may include means, such as processor 202, memory 204, user authentication circuitry 208, challenge data authentication circuitry 214, AI modeling circuitry 216, and/or the like, for determining whether a challenge question validity indication value of a respective challenge question satisfies a challenge question validity indication threshold. In this way, the AI modeling circuitry may determine whether a challenge question is valid based on a challenge question validity indication value associated with the challenge question.

In this regard, the AI modeling circuitry 216 may determine if an open-ended question probability and/or a subject validity probability (e.g., a numerical value or the like) satisfies a respective open-ended question probability threshold and/or a subject validity probability threshold (e.g., a numerical value or the like). The open-ended question probability and/or the subject validity probability may satisfy the open-ended question probability threshold and/or the subject validity probability threshold respectively if the open-ended question probability and/or the subject validity probability is greater than or equal to the open-ended question probability threshold and/or the subject validity probability threshold respectively (e.g., to within an error value of ±1%, ±5%, or any other number). In other examples, the open-ended question probability and/or the subject validity probability may satisfy the open-ended question probability threshold and/or the subject validity probability threshold respectively if the open-ended question probability and/or the subject validity probability is less than or equal to the open-ended question probability threshold and/or the subject validity probability threshold respectively (e.g., to within an error value of ±1%, ±5%, or any other number).

As such, if the AI modeling circuitry 216 determines that both the open-ended question probability and the subject validity probability associated with a respective challenge question satisfy the open-ended question probability threshold and the subject validity probability threshold respectively, the AI modeling circuitry 216 may be configured to assign a challenge question validity indication value to the respective challenge question indicating that the respective challenge question is valid. For example, in embodiments in which the challenge question validity indication value is a binary value, the AI modeling circuitry 216 may assign a challenge question validity indication value of one (1) to the respective challenge question indicating that the respective challenge question is valid. Alternatively, in embodiments in which the challenge question validity indication value is a numerical value within a particular numerical range (e.g., a value between 0.1 and 1, or any suitable numerical range), the AI modeling circuitry 216 may be configured to compare the challenge question validity indication value to a respective challenge question validity indication threshold. In such examples, the AI modeling circuitry 216 may only classify the respective challenge question as valid if the corresponding challenge question validity indication value satisfies the challenge question validity indication threshold.

As such, at operation 608, if the AI modeling circuitry 216 determines that a respective challenge question is an invalid challenge question, the AI modeling circuitry 216 (e.g., in conjunction with the user authentication circuitry 208) may proceed to operation 610 of the flowchart 600. Alternatively, if the AI modeling circuitry 216 determines that a respective challenge question is indeed a valid challenge question, the AI modeling circuitry 216 (e.g., in conjunction with the user authentication circuitry 208) may proceed to operation 612 of the flowchart 600.

As shown by operation 610, the apparatus 200 may include means, such as processor 202, memory 204, user authentication circuitry 208, AI modeling circuitry 216, and/or the like, for discarding a challenge question that has been classified as invalid. For example, upon determining that a respective challenge question is not a valid challenge question, the AI modeling circuitry 216 (e.g., in conjunction with the user authentication circuitry 208) may be configured to cause deletion of the respective challenge question. Additionally or alternatively, upon determining that a respective challenge question is not a valid challenge question, the AI modeling circuitry 216 (e.g., in conjunction with the user authentication circuitry 208) may be configured to revert to operation 604 of the flowchart 600 and, as such, cause the generation of one or more different (e.g., potentially valid) challenge questions to be administered during a respective challenge authentication session.

As shown by operation 612, the apparatus 200 may include means, such as processor 202, memory 204, user authentication circuitry 208, AI modeling circuitry 216, and/or the like, for transmitting valid challenge questions. For example, as described herein, upon determining that a respective challenge question is a valid challenge question, the AI modeling circuitry 216 (e.g., in conjunction with the user authentication circuitry 208) may be configured to cause transmission of the respective challenge question to a client computing device (e.g., client computing device 108A) associated with a respective user during a challenge authentication session. In this manner, the AI modeling circuitry 216 (e.g., in conjunction with the user authentication circuitry 208) may be configured to ensure that only valid challenge questions are administered during a respective challenge authentication session.

FIGS. 4A, 4B, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved, dynamic, and passwordless user authentication. Example embodiments thus provide tools that overcome the problems faced by conventional user authentication mechanisms (e.g., passwords, passcodes, fingerprint-based mechanisms, physical security tokens, conventional digital certificates). By avoiding the use of conventional user authentication mechanisms, example embodiments thus save time and resources, while also eliminating the possibility of fraudulent user authentication attempts. Moreover, embodiments described herein counter a wide variety of emerging risks in an evolving technological landscape.

For instance, example embodiments provide protection against fraudulent audio input and/or image input scenarios, such as deep fakes, synthetic media, and/or the like, (e.g., by detecting a bad actor in the background of a user’s image input) and counteract various computer-generated threats (e.g., AI-generated images (a.k.a. deep fakes), audio impersonation software, forced authentication attacks, and/or the like) configured to fraudulently access private and/or sensitive data associated with a user and/or enterprise. Furthermore, by employing the AI-based user authentication model described herein to generate synthetic data (e.g., synthetic audio data and/or synthetic image data) representative of a user, example embodiments may iteratively improve themselves by training and/or re-training said user authentication model based on scenarios that have yet to occur (e.g., forced authentication attacks, bad actor attacks, impersonation attacks). As such, example embodiments leverage AI technologies to make the user authentication management system described herein more robust against future user authentication fraud. Finally, example embodiments described herein offer further protection and accessibility for primary users with various technological accessibility needs by employing AI-based user authentication techniques that accommodate the presence and utilization of secondary users (e.g., caretakers, healthcare aides) for safely authenticating the primary users with various technological accessibility needs.

As these examples all illustrate, example embodiments contemplated herein provide technical solutions that solve real-world problems faced while using network-based software application framework technologies to access sensitive and/or private data. And while fraud such as identity theft and user impersonation has been an issue for decades, the ubiquitous use of online accounts, web-based user profiles, and network-accessible data related to both enterprises and individuals has made this problem significantly more acute, especially as cyber-fraud techniques become more sophisticated. At the same time, the recently arising ubiquity of AI-based technologies has unlocked new avenues to solving these problems that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for passwordless user authentication, the method comprising:
receiving, by communications hardware, a user authentication request for a user;
facilitating, by user authentication circuitry, an audio-visual authentication session comprising:
receiving, by the communications hardware, one or more of audio input data or image input data, and
determining, by the user authentication circuitry, whether one or more of the audio input data or the image input data are valid;
facilitating, by the user authentication circuitry, a challenge authentication session comprising:
transmitting, by the user authentication circuitry, one or more challenge questions,
receiving, by the communications hardware, a first user response to at least a first challenge question of the one or more challenge questions, wherein the first challenge question is characterized by a first degree of difficulty, and
determining, by the user authentication circuitry, whether the first user response to the first challenge question is valid; and
granting or denying, by the user authentication circuitry, one or more access permissions.

2. The method of claim 1, wherein facilitating the audio-visual authentication session further comprises:
generating, by audio data authentication circuitry and based on the audio input data, an audio data similarity score, wherein the audio data similarity score is generated based on a comparison of the audio input data to stored audio data associated with the user;
generating, by image data authentication circuitry and based on the image input data, an image data similarity score, wherein the image data similarity score is generated based on a comparison of the image input data to stored image data associated with the user;
determining, by the user authentication circuitry, whether the audio data similarity score satisfies an audio data similarity score threshold;
determining, by the user authentication circuitry, whether the image data similarity score satisfies an image data similarity score threshold;
in response to determining that the audio data similarity score and the image data similarity score fail to satisfy one or more of the audio data similarity score threshold or the image data similarity score threshold:
initiating, by the user authentication circuitry, facilitation of a second audio-visual authentication session; and
in response to determining that the audio data similarity score and the image data similarity score satisfy both of the audio data similarity score threshold and the image data similarity score threshold respectively:
initiating facilitation, by the user authentication circuitry, of the challenge authentication session.

3. The method of claim 2, further comprising:
in response to determining that the audio data similarity score and the image data similarity score satisfy both of the audio data similarity score threshold and the image data similarity score threshold respectively:
classifying, by the user authentication circuitry, the audio input data as validated audio data and updating the stored audio data to include the validated audio data; and
generating, by AI modeling circuitry and based on the stored audio data, synthetic audio data that is representative of the user, wherein the synthetic audio data is used in part to authenticate the user during subsequent audio-visual authentication sessions.

4. The method of claim 2, further comprising:
in response to determining that the audio data similarity score and the image data similarity score satisfy both of the audio data similarity score threshold and the image data similarity score threshold respectively:
classifying, by the user authentication circuitry, the image input data as validated image data and updating the stored image data to include the validated image data; and
generating, by AI modeling circuitry and based on the stored image data, synthetic image data that is representative of the user, wherein the synthetic image data is used in part to authenticate the user during subsequent audio-visual authentication sessions.

5. The method of claim 2, wherein the user is a primary user, wherein at least one or more of the audio input data or the image input data are associated with a secondary user, and wherein the secondary user is a trusted user associated with the user.

6. The method of claim 1, wherein facilitating the challenge authentication session further comprises:
determining, by the user authentication circuitry, that the first user response fails to match a first expected response; and
causing transmission, by the user authentication circuitry, of a second challenge question of the one or more challenge questions generated by AI modeling circuitry to a client computing device, wherein the second challenge question is characterized by a second degree of difficulty, and wherein the second degree of difficulty is an increased level of difficulty relative to the first degree of difficulty associated with the first challenge question.

7. The method of claim 1, further comprising:
in response to determining that a user has failed to respond successfully to a predetermined number of challenge questions of the one or more challenge questions:
generating, by the user authentication circuitry, a suspected fraudulent activity notification;
causing transmission, by the user authentication circuitry, of the suspected fraudulent activity notification to one or more enterprise computing devices associated with an enterprise; and
initiating, by the user authentication circuitry, facilitation of a new audio-visual authentication session.

8. The method of claim 1, further comprising:
generating, by AI modeling circuitry, a user persona for the user based on one or more of biological data, personal data, online activity data, offline activity data, financial activity data, accessibility data, challenge question response metrics, historical user authentication data, validated audio data, validated image data, synthetic audio data, and synthetic image data that is representative of the user.

9. The method of claim 8, further comprising:
generating, by the AI modeling circuitry, the one or more challenge questions to be administered during the challenge authentication session, wherein the one or more challenge questions are dynamically generated based on the user persona associated with the user, and wherein each challenge question of the one or more challenge questions is characterized by a respective degree of difficulty.

10. The method of claim 9, further comprising:
generating, by the AI modeling circuitry, one or more expected responses to the one or more challenge questions, wherein the one or more expected responses are generated based on the user persona associated with the user.

11. The method of claim 9, wherein generating the one or more challenge questions further comprises:
generating, by the AI modeling circuitry and for each challenge question of the one or more challenge questions, a challenge question validity indication value, wherein the challenge question validity indication value indicates whether the one or more challenge questions satisfy one or more of an open-ended question probability threshold or a subject validity probability threshold; and
in response to determining, by the AI modeling circuitry and based on the challenge question validity indication value, that the first challenge question is a valid challenge question:
causing transmission, by the user authentication circuitry, of the first challenge question to a client computing device during the challenge authentication session.

12. An apparatus for passwordless user authentication, the apparatus comprising:
communications hardware configured to:
receive a user authentication request for a user; and
user authentication circuitry configured to:
facilitate an audio-visual authentication session comprising:
receiving, by the communications hardware, one or more of audio input data or image input data, and
determining whether one or more of the audio input data or the image input data are valid;
facilitate a challenge authentication session comprising:
transmitting one or more challenge questions,
receiving, by the communications hardware, a first user response to at least a first challenge question of the one or more challenge questions, wherein the first challenge question is characterized by a first degree of difficulty, and
determining, by the user authentication circuitry, whether the first user response to the first challenge question is valid; and
grant or deny one or more access permissions.

13. The apparatus of claim 12, wherein the apparatus further comprises:
audio data authentication circuitry configured to:
generate, based on the audio input data, an audio data similarity score, wherein the audio data similarity score is generated based on a comparison of the audio input data to stored audio data associated with the user; and
image data authentication circuitry configured to:
generate, based on the image input data, an image data similarity score, wherein the image data similarity score is generated based on a comparison of the image input data to stored image data associated with the user,
wherein the user authentication circuitry is further configured to:
determine whether the audio data similarity score satisfies an audio data similarity score threshold;
determine whether the image data similarity score satisfies an image data similarity score threshold;
in response to determining that the audio data similarity score and the image data similarity score fail to satisfy one or more of the audio data similarity score threshold or the image data similarity score threshold:
initiate facilitation of a second audio-visual authentication session; and
in response to determining that the audio data similarity score and the image data similarity score satisfy both of the audio data similarity score threshold and the image data similarity score threshold respectively:
initiate facilitation of the challenge authentication session.

14. The apparatus of claim 13, wherein the user authentication circuitry is further configured to:
in response to determining that the audio data similarity score and the image data similarity score satisfy both of the audio data similarity score threshold and the image data similarity score threshold respectively:
classify the audio input data as validated audio data and updating the stored audio data to include the validated audio data,
wherein the apparatus further comprises AI modeling circuitry configured to:
generate, based on the stored audio data, synthetic audio data that is representative of the user, wherein the synthetic audio data is used in part to authenticate the user during subsequent audio-visual authentication sessions.

15. The apparatus of claim 13, wherein the user authentication circuitry is further configured to:
in response to determining that the audio data similarity score and the image data similarity score satisfy both of the audio data similarity score threshold and the image data similarity score threshold respectively:
classify the image input data as validated image data and updating the stored image data to include the validated image data,
wherein the apparatus further comprises AI modeling circuitry configured to:
generate, based on the stored image data, synthetic image data that is representative of the user, wherein the synthetic image data is used in part to authenticate the user during subsequent audio-visual authentication sessions.

16. The apparatus of claim 12, wherein the user authentication circuitry is further configured to:
determine, during the challenge authentication session, that the first user response fails to match a first expected response; and
cause transmission of a second challenge question of the one or more challenge questions generated by AI modeling circuitry to a client computing device, wherein the second challenge question is characterized by a second degree of difficulty, and wherein the second degree of difficulty is an increased level of difficulty relative to the first degree of difficulty associated with the first challenge question.

17. The apparatus of claim 12, wherein the user authentication circuitry is further configured to:
in response to determining that a user has failed to respond successfully to a predetermined number of challenge questions of the one or more challenge questions:
generate a suspected fraudulent activity notification;
cause transmission of the suspected fraudulent activity notification to one or more enterprise computing devices associated with an enterprise; and
initiate facilitation of a new audio-visual authentication session.

18. The apparatus of claim 12, wherein
the apparatus further comprises AI modeling circuitry configured to:
generate a user persona for the user based on one or more of biological data, personal data, online activity data, offline activity data, financial activity data, accessibility data, challenge question response metrics, historical user authentication data, validated audio data, validated image data, synthetic audio data, and synthetic image data that is representative of the user.

19. The apparatus of claim 18, wherein the AI modeling circuitry is further configured to: generate the one or more challenge questions to be administered during the challenge authentication session, wherein the one or more challenge questions are dynamically generated based on the user persona associated with the user, and wherein each challenge question of the one or more challenge questions is characterized by a respective degree of difficulty.

20. A computer program product for passwordless user authentication, the computer program product comprising at least one non-transitory computer-readable storage medium storing software instructions that, when executed, cause an apparatus to:
receive, by communications hardware, a user authentication request for a user;
facilitate, by user authentication circuitry, an audio-visual authentication session comprising:
receiving, by the communications hardware, one or more of audio input data or image input data, and
determining, by the user authentication circuitry, whether one or more of the audio input data or the image input data are valid;
facilitate, by the user authentication circuitry, a challenge authentication session comprising:
transmitting, by the user authentication circuitry, one or more challenge questions,
receiving, by the communications hardware, a first user response to at least a first challenge question of the one or more challenge questions, wherein the first challenge question is characterized by a first degree of difficulty, and
determining, by the user authentication circuitry, whether the first user response to the first challenge question is valid; and
grant or deny, by the user authentication circuitry, one or more access permissions.
